(19) United States
(12) Patent Application Publication
(10) Pub. No.: US 2025/0360051 A1
(43) Pub. Date: Nov. 27, 2025

(54) WEARABLE DEVICE FOR IMPROVING VASCULAR INSUFFICIENCY TO THE EXTREMITIES

(71) Applicant: The Penn State Research Foundation, University, PA (US)

(72) Inventors: Charles Palmer, Hummelstown, PA (US); William J. Weiss, Mechanicsburg, PA (US)

(21) Appl. No.: 19/287,163

(22) Filed: Jul. 31, 2025

Related U.S. Application Data
(63) Continuation-in-part of application No. 18/066,333, filed on Dec. 15, 2022, now Pat. No. 12,390,393.
Application No. 18/066,333 is a continuation of application No. 16/345,305, filed on Apr. 26, 2019, now Pat. No. 11,554,076.
(60) Provisional application No. 62/414,042, filed on Oct. 28, 2016.

(51) Int. Cl. A61H 31/02; A61H 31/00

(52) U.S. Cl. CPC A61H 31/02; A61H 2031/002; A61H 2031/003; A61H 2201/0192; A61H 2201/1238; A61H 2201/1621; A61H 2201/5058; A61H 2230/045; A61H 2230/085; A61H 2230/405

(57) ABSTRACT

A device for treating vascular insufficiency is described. The device includes a flexible and elastic tubular structure attached to a base layer. The flexible and elastic tubular structure include an air inlet, where longitudinal expansion of a first portion of the tubular structure is less restricted than radial expansion of the first portion of the tubular structure. A fastener is attached to the base layer and configured to fasten the base layer circumferentially around a limb. A method for treating vascular insufficiency is also described.

### CROSS-REFERENCE TO RELATED APPLICATIONS

This application is a continuation-in-part of U.S. application Ser. No. 18/066,333, filed Dec. 15, 2022, which is a continuation of U.S. application Ser. No. 16/345,305, filed Apr. 26, 2019, which is a national stage filing of International application No. PCT/US17/58949 filed on Oct. 30, 2017, which claims priority to U.S. provisional application No. 62/414,042 filed on Oct. 28, 2016, all of which are incorporated herein by reference in their entireties.

### BACKGROUND OF THE INVENTION

Newborn babies, especially those born prematurely, can experience a range of breathing issues immediately after being born. Premature infants with respiratory distress have stiff lungs and a compliant chest wall. The soft rib cage and compliant chest wall in neonates can result in the chest wall readily collapsing during spontaneous respiration. Further, neonates often have to do extra work in breathing to overcome the chest wall retraction, and the lack of chest wall rigidity allows the lung to collapse. A collapsed lung is more difficult for the neonate to inflate. Therefore, premature infants often require assistance to maintain adequate lung volumes. This is achieved by providing mechanical ventilation or continuous distending pressure.

Several methods and devices for assisting neonatal breathing are known in the art. For example, continuous positive airway pressure (CPAP) can be an effective method for assisting breathing, preventing chest wall collapse, and providing distending pressure. However, CPAP can have major side-effects, such as airway drying and obstruction of nasal passages, and the erosion of the nasal septum from pressure necrosis. Even when positive distending pressure is applied non-invasively, i.e., without endotracheal intubation, it fails to support spontaneous respiration in 30-50% of preterm infants with respiratory distress. These infants are then intubated, given surfactants and mechanically ventilated. Mechanical ventilation via an endotracheal tube is associated with injury to the lung and chronic lung disease. Further, chronic lung disease is associated with neurodevelopmental impairment. Accordingly, clinicians caring for preterm infants with respiratory distress prefer to support spontaneous respiration without the need for intubation and mechanical ventilation. In addition, the cost of surfactants is prohibitive in some countries. Therefore, non-invasive ventilation of a neonate, for example the application of negative distending pressure, is preferred over intubation and positive pressure ventilation.

Methods and devices for applying negative distending pressure known in the art include the neonatal chest brace described by Palmer et al. (U.S. Pat. No. 6,533,739). While the chest brace in Palmer represents a notable advancement in the field, it is not suitable for certain applications, because it requires a rigid brace that can interfere with the delicate condition of most neonates, especially those born prematurely. Specifically, in certain applications the rigid brace is not sufficiently flexible for applying delicate adjustments to the negative distending pressure in a neonate. The infants that fail non-invasive ventilation with CPAP are typically the smallest and most immature, for example those weighing less than 1000 grams. The chest brace in Palmer is not suitable for these infants, who require a more delicate means of negative distension. The chest brace is also mechanically complicated and is not easily applied. Further, the chest brace does not permit active ventilation of the neonate and it does not permit oscillation of the chest wall.

In addition, the surface of the chest on a newborn can be very contoured as the ribcage buckles inward and the infant struggles to breathe. Thus, conventional devices that are rigid or otherwise utilize planar surfaces are at a disadvantage, since the rigid or planar surfaces will not easily mate with the contoured surface of the infant's chest. Thus, if the device can only contact the patient at a limited number of points, the forces at those limited number of points will experience higher stress versus a device that can contact the body over a larger surface area. Still further, newborns are born of different shapes and sizes, and it would be beneficial to have a device that is easily adaptable to fit the shape and size of the patient.

In addition to pulmonary insufficiency in newborns, there are other conditions in children and adults that could benefit from an improved device for assisting the patient's breathing. For example, infants in the first year of life have chest wall retractions when they present with a viral chest infection like bronchiolitis. In another example, in an acute respiratory failure or CPR scenario, emergency medical professionals could benefit from an improved device that is easy to position on the patient and immediately assists with the patient's breathing. Other medical circumstances or conditions that could benefit from an improved device include any condition causing muscle weakness, post-surgery anesthesia recovery, asthma, opioid overdose (or any condition with respiratory depression) and cardiac failure.

Moreover, in the field there are few, if any, effective technologies available for improving arterial supply to the extremities. One approach uses intermittent pneumatic compression, where compression is produced by inflating cuffs wrapped around the foot and calf. Another approach is produced by intermittent decompression produced by immersing the leg in a negative pressure chamber. Both these approaches increase the Arterial-Venous pressure gradient thereby increasing blood flow.

Intermittent compression is also used to prevent venous stasis and deep vein thrombosis. Intermittent pneumatic compression used for the purpose of increasing arterial blood flow uses short 3 s pressure pulses of rapid onset <300 ms) of about 120 mmHg. These pulses are repeated approximately 3 times a minute. The pressure is delivered sequentially to the foot then 1 sec later to the calf. This protocol produces venous emptying and a drop in venous pressure without affecting arterial pressure, thereby increasing the arterial-venous gradient and improving blood flow. The rapid cuff inflation (<300 ms) produces increases shear forces on endothelial cells, triggering release of nitric oxide and vasodilatory mediators leading to acute vasodilation and improved microcirculation.

In contrast to intermittent compression, decompression of limbs such as the leg using a negative pressure chamber has also been shown to improve arterial supply (e.g. FlowOx2, Otivio AS, Oslo Norway). While effective, conventional decompression modalities are cumbersome, require an effective and reliable seal which can be difficult to achieve, and are not commercially available. Thus, both intermittent compression and decompression can improve arterial supply and could be potentially synergistic in mechanism but there are no technologies that provide both.

Concerning positive pressure therapy, compression to the leg with various methods is widely used to prevent venous stasis and thrombosis. Intermittent sequential compression site therapy is used for the prevention of deep vein thrombosis and used to improve lymphatic drainage. Commercially available technologies including compression stockings, inflatable cuffs, or pressure chambers are used to provide positive pressure. In contrast to improving venous flow there is little technology for improving arterial flow in the setting of diminished arterial supply caused by peripheral vascular disease.

Concerning negative pressure therapy, Critical Lower Limb Ischemia (CLI) is recognized in patients with persistent ischemic pain of the lower extremity that may need analgesia, and it is associated with tissue loss from ischemia. Some patients respond to reconstructive arterial surgery to the arterial supply but over 25% require amputation. The prevalence of CLI in patients aged 40-69 years is reported to be 0.24% or about 1 in 1000 people and prevalence increases with age. Constant negative pressure applied to the skin causes reflex vasospasm. However, intermittent negative pressure applied around the lower leg improves blood flow in patients who have impaired arterial blood supply. The negative pressure is applied intermittently to avoid reflex vasospasm, and intermittent pressures of about −40 mmHg have been shown to produce the most effective improvement compared to higher or lower negative pressures tested. The pressure cycle used by Sundby et al included negative pressure level of −40 mmHg cycled on suction (negative pressure to limb) for 10 s followed by 7 sec atmospheric pressure. This protocol has been shown to improve laser doppler flux (LDF) indicating improved tissue flow by 24% and ultrasound doppler flow in the foot arteries by 39%. However, the technology used to create the negative pressure is rather cumbersome, consisting of a negative pressure chamber that must be adequately sealed around the limb and a pump for creating the negative pressure (see e.g. Sundby O H et al., “The acute effects of lower limb intermittent negative pressure on foot macro- and microcirculation in patients with peripheral arterial disease,” PLOS ONE, 12 (6), e0179001). This makes treating areas of the patient, for example, above the knee more difficult as the pressure chamber must include the upper and lower leg.

Thus, there is a need in the art for a minimally or non-invasive modular and comfortable device that can provide respiratory support and the benefits of both positive and negative pressure therapy for facilitating venous, lymphatic and arterial circulation, without the drawbacks of conventional devices.

### SUMMARY OF THE INVENTION

In one embodiment, a device includes a first tube having a flexible and elastic material that forms a first tube lumen extending from a proximal end to a distal end of the first tube, where longitudinal expansion of the first tube is restricted less than radial expansion of the first tube, and a connection element including an air supply port in fluid communication with an open proximal end of the first tube lumen and attached to a proximal end of the first tube. In one embodiment, the device includes a second tube comprising a flexible and elastic material that forms a second tube lumen, wherein the second tube lumen extends from an open proximal end to a closed distal end of the second tube, and wherein longitudinal expansion of the second tube is restricted less than radial expansion of the second tube; wherein the connection element comprises a second air supply port in fluid communication with an open proximal end of the second tube lumen and attached to a proximal end of the second tube. In one embodiment, the first air supply port is in fluid communication with the second air supply port through a branched connection off a primary air conduit. In one embodiment, the device includes a third tube comprising a flexible and elastic material that forms a third tube lumen, wherein the third tube lumen extends from an open proximal end to a closed distal end of the third tube, and wherein longitudinal expansion of the third tube is restricted less than radial expansion of the third tube; wherein the connection element comprises a third air supply port in fluid communication with an open proximal end of the third tube lumen and attached to a proximal end of the third tube. In one embodiment, the first air supply port is in fluid communication with the second and third air supply port through a branched connection off a primary air conduit. In one embodiment, the first tube is one of a plurality of tubes comprising a flexible and elastic material, and wherein the plurality of tubes are embedded in a flexible and elastic layer. In one embodiment, at least one sensor is at least partially embedded in the flexible and elastic layer. In one embodiment, the sensor is configured to detect a signal indicative of at least one of heart rate, respiratory effort, chest displacement and tube function. In one embodiment, the first tube is at least partially embedded in silicone foam. In one embodiment, the first tube is at least partially embedded in silicone. In one embodiment, a medical-grade skin adhesive is disposed directly on the silicone. In one embodiment, a surface of the silicone is plasma treated where the medical-grade skin adhesive is disposed. In one embodiment, the adhesive is a silicone adhesive. In one embodiment, radial expansion of the first tube is completely restricted. In one embodiment, longitudinal expansion of the first tube is substantially free from restriction. In one embodiment, longitudinal expansion of the first tube is variably restricted. In one embodiment, restriction of radial expansion of the first tube is provided at least partially by one or more restrictive fibers or wires connected to the flexible and elastic material. In one embodiment, the distal end of the first tube lumen is closed. In one embodiment, the distal end of the first tube lumen is open, and device includes a second connection element including a second air supply port in fluid communication with the open distal end of the first tube lumen and attached to the distal end of the first tube. In one embodiment, the device includes a second tube comprising a flexible and elastic material that forms a second tube lumen, wherein the second tube lumen extends from an open proximal end to a closed distal end of the second tube, and wherein longitudinal expansion of the second tube is restricted less than radial expansion of the second tube, where the connection element comprises a branch connected to the air supply port in fluid communication with the proximal end of the second tube lumen and attached to a proximal end of the second tube. In one embodiment, the device includes a third tube comprising a flexible and elastic material that forms a third tube lumen, wherein the third tube lumen extends from an open proximal end to a closed distal end of the third tube, and wherein longitudinal expansion of the third tube is restricted less than radial expansion of the third tube, where the connection element comprises a branch connected to the air supply port in fluid communication with the proximal end of the third tube lumen and attached to a proximal end of the third tube. In one embodiment, at least one of the longitudinal restrictions of the first tube is different than at least one of the longitudinal restrictions of the second tube. In one embodiment, the device includes a controller operably connected to the first distension device, where the controller is configured to drive a signal to an air pump for generating a pressure within the first tube. In another embodiment more than three tubes can be placed side by side and connected to the air source to provide a wider surface area of attachment to, for example, a chest wall. In another embodiment the tubes are imbedded in silicone. In such an embodiment the surface of the silicone is soft and pliable and allows the attachment to the skin with an adhesive. In one embodiment, the signal is based at least partially on sensor feedback. In one embodiment, the device includes a first and second distension device, where the first distension device is designated for attachment to, for example, the chest of the subject, and wherein the second distension device is designated for attachment to, for example, the abdomen of the subject. In another embodiment the tube assembly covers the ribcage and abdomen. In one embodiment, the device includes a controller operably connected to the first and second distension device. In one embodiment, the controller is configured to independently drive the expansion of the first and second distension devices. In one embodiment, the controller is configured to oscillate inflation of one distension device while providing a constant inflation to the other distension device. In one embodiment, the controller is configured to oscillate inflation of one distension device and oscillate inflation of the other distension device, and wherein the oscillations are centered around a different average pressure. In one embodiment, the controller is configured to oscillate inflation of one distension device and oscillate inflation of the other distension device, and wherein the oscillations are out of sync. In one embodiment, the device includes at least one sensor, and the controller is configured to change operation of the first and second distension devices based on feedback detected from the at least one sensor. In one embodiment, the change in operation is at least one of synchronization, displacement, oscillation, static pressure or an on/off operational state. In one embodiment the device can apply a constrictive force to the chest for varying time intervals including oscillation. To produce a compressive force to a region of a body, for example the chest, the device needs to be sufficiently elastic to allow an applied vacuum to shrink the device. In one embodiment, the device includes an adhesive for attaching the first tube to a surface of the subject. In one embodiment, the adhesive is an elongate strip. In one embodiment, the device includes an attachment mechanism or fastening element for attaching the first tube to the subject's skin, and a means for anchoring a proximal and distal anchor to the subject's skin. In one embodiment, the attachment mechanism comprises a hook and loop fastener. In one embodiment, at least a portion of the hook and loop fastener provides restriction of radial expansion of the first tube. In one embodiment, the attachment mechanism includes a skin protective layer including at least one of a hydrogel, silicone a hydrocolloid dressing or a semipermeable membrane. In another embodiment, an elastic adhesive is the method of attachment with the elastic adhesive applied to the surface of the tubes in contact with the skin. In one embodiment, the first tube lumen is inflated by transferring air to the lumen via a syringe or a bulb syringe. In one embodiment, the first tube lumen is inflated by transferring air to the lumen via a ventilator or an air pump. In one embodiment, at least a portion of a surface of the first tube comprises a soft fabric. In one embodiment, the subject is a neonate. In one embodiment, a respirator includes the distension device.

In one embodiment, a device for expanding and compressing a region of a subject comprises a flexible and elastic tubular structure attached to a base layer. In some embodiments the flexible and elastic tubular structure comprises an air supply port, wherein longitudinal expansion of a first portion of the flexible and elastic tubular structure is less restricted than radial expansion of the first portion of the flexible and elastic tubular structure, and a fastening element attached to the base layer and configured to fasten the base layer circumferentially around a limb. In some embodiments the air supply port is a proximal air inlet and the flexible and elastic tubular structure further comprises a closed distal end. In some embodiments, the flexible and elastic tubular structure comprises a plurality of flexible and elastic tubes. In some embodiments, each of the plurality of flexible and elastic tubes has a closed distal end and an open proximal end connected to the proximal air inlet via a proximal end branch. In some embodiments, the fastening element comprises a proximal and distal end fastening component configured to mate with each other, wherein at least one of the proximal and distal end fastening components is at least one of a magnet, hook, loop fastener, button, clip, zipper, adhesive, buckle, toggle, belt, lace, cord, cinch or combination thereof. In some embodiments, the base layer is substantially planar. In some embodiments, the device further comprises a pneumatic pump connected to the air supply port, a skin adhesive layer disposed on the base layer, and a sensor attached to at least one of the base layer and the first flexible and elastic tubular structure. In some embodiments, the air supply port forms part of a 3-way junction including first and second ends of the first flexible and elastic tubular structure.

In one embodiment, a method for assisting breathing in a subject includes the steps of attaching a first flexible and elastic tube having a first lumen to the body, for example, chest or abdomen of a subject, anchoring a proximal and distal end of the at least first tube to a first and second posterolateral or posterior region of the subject, inflating the at least first tube by transferring air into first lumen, and applying a negative distending pressure to the subject's chest or abdomen via the inflating. In one embodiment, the method includes the step of at least partially deflating the at least first tube to reduce the negative distending pressure applied to the subject's chest or abdomen. In one embodiment, the method includes the step of attaching the at least first tube to the subject's chest or abdomen by a skin attachment mechanism. In one embodiment, the skin attachment mechanism is a hydrogel. In one embodiment, the skin attachment mechanism is a hydrocolloid. In one embodiment, the skin attachment mechanism is a semi-permeable membrane dressing. In one embodiment the attachment mechanism is a silicone adhesive. In one embodiment, the at least first tube is in continuous contact with the subject's chest or abdomen. In one embodiment, the method includes the step of transferring air into the first lumen via a syringe or a bulb syringe. In one embodiment, the method includes the step of transferring air into the first lumen via a ventilator or an air pump. In one embodiment, the method includes the step of transferring a predetermined amount of air into the first lumen to inflate the at least one first tube. In one embodiment, the predetermined amount of air corresponds to an application of negative distending pressure to the subject's chest or abdomen that causes the subject to inhale a breath approximately equal to or less than the tidal volume. In one embodiment, the inflation of the at least one tube is synchronized with the spontaneous inspiration of the subject. In one embodiment, the negative distending pressure applied to the subject's chest or abdomen is statically maintained for a predetermined period of time. In one embodiment, the method includes the step of deflating the at least one tube to release the negative distending pressure. In one embodiment, a vacuum pressure is applied to the tube. In one embodiment, a vacuum pressure applied to the tube generates a constrictive force on the chest wall, applying a positive pressure to the chest to facilitate the elimination of secretions in the lung. In one embodiment, the inflating or deflating of the at least one tube is controlled based on sensor feedback of the subject's diaphragm. In one embodiment, the operation of the at least one tube is based on sensor feedback. In one embodiment, the step of applying a negative distending pressure comprises high frequency oscillations. In another embodiment the step of applying a positive compressive pressure comprises high frequency oscillations. In one embodiment, the first flexible tube is one of a plurality of flexible tubes embedded in silicone. In one embodiment, the method includes the steps of applying a vacuum pressure to the first lumen. In one embodiment, the method includes the steps of generating a constrictive force on the chest wall, and applying a positive pressure to the chest to facilitate the elimination of secretions in the lung.

In one embodiment, a device for treating vascular insufficiency includes a flexible and elastic tubular structure attached to a base layer, the flexible and elastic tubular structure comprising an air inlet, wherein longitudinal expansion of a first portion of the tubular structure is less restricted than radial expansion of the first portion of the tubular structure; and a fastener attached to the base layer and configured to fasten the base layer circumferentially around a limb. In one embodiment, the air inlet is a proximal air inlet and the flexible and elastic tubular structure further comprises a closed distal end. In one embodiment, the flexible and elastic tubular structure comprises a plurality of tubes. In one embodiment, each of the plurality of tubes has a closed distal end and an open proximal end connected to the proximal air inlet via a proximal end branch. In one embodiment, the fastener comprises a proximal and distal end fastening component configured to mate with each other. In one embodiment, at least one of the proximal and distal end fastening components is a hook and loop fastener. In one embodiment, at least one of the proximal and distal end fastening components is at least one of a magnet, hook, button, clip, zipper, adhesive, buckle, toggle, belt, lace, cord or cinch. In one embodiment, the base layer is substantially planar. In one embodiment, the device includes a pneumatic pump connected to the air inlet. In one embodiment, the device includes a skin adhesive layer disposed on the base layer. In one embodiment, a kit includes the device and a skin adhesive. In one embodiment, a sensor is attached to at least one of the base layer and the tubular structure. In one embodiment, the air inlet forms part of a 3-way junction including first and second ends of the flexible and elastic tubular structure.

In one embodiment, a method for treating vascular insufficiency includes the steps of providing the device; circumferentially wrapping the base layer around a limb region of a subject; applying a positive intraluminal pressure within the tubular structure to decompress the limb region; and applying a negative intraluminal pressure within the first lumen to compress the limb region. In one embodiment, at least one of the applying a positive intraluminal pressure and applying a negative intraluminal pressure is based on sensor feedback. In one embodiment, the sensor feedback is measured from the limb region. In one embodiment, the sensor feedback is a signal indicative of at least one of heart rate, ECG, blood flow, temperature, respiratory effort, chest displacement and tube function. In one embodiment, the sensor is connected to at least one of the base layer and the tubular structure. In one embodiment, the method includes the step of holding a predetermined positive intraluminal pressure for a predetermined amount of time. In one embodiment, the predetermined positive intraluminal pressure is determined based on sensor feedback. In one embodiment, the predetermined amount of time is based on sensor feedback. In one embodiment, the predetermined positive intraluminal pressure is less than full positive intraluminal pressure. In one embodiment, the method includes the step of holding a predetermined negative intraluminal pressure for a predetermined amount of time. In one embodiment, the predetermined negative intraluminal pressure is determined based on sensor feedback. In one embodiment, the predetermined amount of time is based on sensor feedback. In one embodiment, the predetermined negative intraluminal pressure is more than full negative intraluminal pressure. In one embodiment, the method includes the step of attaching the base layer to a limb region of a subject by applying a skin attachment mechanism. In one embodiment, the skin attachment mechanism is a skin adhesive. In one embodiment, a flexible elastic protective layer is applied to the skin prior to adhering the base layer. In one embodiment, the flexible elastic protective layer comprises a hydrocolloid material. In one embodiment, the step of applying a negative intraluminal pressure comprises high frequency oscillations. In one embodiment, the step of applying a positive intraluminal pressure comprises high frequency oscillations. In one embodiment, the method includes the step of oscillating between first and second positive intraluminal pressures. In one embodiment, the method includes the step of oscillating between first and second negative intraluminal pressures. In one embodiment, the method includes the step of oscillating between a positive intraluminal pressure and a negative intraluminal pressure. In one embodiment, the base layer is wrapped around the limb region of the subject in a spiral. In one embodiment, the base layer is anchored to the subject at a first and second anchor region of the base layer. In one embodiment, the first and second anchor region of the base layer are inelastic.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1A is a side view of a distension system according to one embodiment, and FIG. 1B is a distension system diagram according to one embodiment.

FIG. 2A is a side view of a distension device having radially restricting fibers (including a magnified view of the tube) according to one embodiment, FIG. 2B is a cross-sectional view of the tube according to one embodiment, FIG. 2C is an image of a tube portion having helical restricting fibers, and FIG. 2D is an image of a tube portion having convolutions incorporated into the tube wall.

FIG. 3 is a side view of a distension device having three tubes according to one embodiment.

FIG. 4A is a side view of a distension device tube wrapped with a fastening element, and FIG. 4B is a cross-sectional view of the tube and fastening element according to one embodiment.

FIG. 5A is a perspective view of a single tube distension device on an infant according to one embodiment, FIG. 5B is a diagram of an unpressurized tube and a pressured tube on the body according to one embodiment, FIG. 5C is a perspective view of a two-tube distension device system on an infant according to one embodiment, FIG. 5D is a diagram of an unpressurized tube and a pressured tube on a body having a concave chest according to one embodiment, and FIG. 5E is a diagram of a chest expander asymmetrically applied according to one embodiment.

FIG. 6A is a cross-sectional view of a distension device attached to a subject according to one embodiment, FIG. 6B is a cross-sectional view of a distension device having a length adjustment clamp attached to a subject according to one embodiment, FIG. 6C is a cross-sectional view of a distension device having a restraining strap attached to a subject according to one embodiment, and FIG. 6D is a cross-sectional view of a distension device having a tapered tube extension according to one embodiment.

FIG. 7A is a perspective and magnified partial cutaway view (620) of a chest expander having multiple tubes embedded in silicone according to one embodiment, FIG. 7B is a perspective view of a chest expander having multiple tubes embedded in silicone according to one embodiment, FIG. 7C is a top view of a silicone plethysmography sensor according to one embodiment, FIG. 7D is an exploded view of the connection element and corresponding tubes according to one embodiment, FIG. 7E is a perspective view of a chest expander on a patient according to one embodiment, and FIG. 7F is a perspective view of a chest expander and an abdomen expander on a patient according to one embodiment.

FIG. 8A is a graph of various inflation modes according to one embodiment, FIG. 8B is a table of respiratory rate ranges for various ages according to one embodiment, and FIG. 8C is a chart showing exemplary modes of device inflation/deflation according to one embodiment.

FIG. 9 is a flow chart of a method for assisting breathing according to one embodiment.

FIG. 10 is a diagram of a leg with a flexible and elastic tubular structure wrapped around a lower leg and a foot according to one embodiment.

FIG. 11 is a diagram of flexible and elastic tubular structure components according to one embodiment.

FIG. 12 is a diagram of a cross-section A-A′ of FIG. 10 according to one embodiment.

FIG. 13 is a diagram of a flexible and elastic tubular structure having a pressure sensor according to one embodiment.

FIGS. 14A and 14B are diagrams of a flexible tube with a closed distal end and an air supply inlet at the open proximal end (FIG. 14A) according to one embodiment and a flexible tube with first and second ends connected to the air supply inlet at a 3-way junction (FIG. 14B) according to one embodiment.

FIG. 15 is a flow chart of a method for treating vascular insufficiency according to one embodiment.

FIG. 16A is a diagram of an experimental setup of a chest expander placed on a mannequin according to one embodiment, and FIGS. 16B and 16C are a graph and chart respectively of movement, flow and pressure data acquired from the experimentation.

### DETAILED DESCRIPTION OF THE INVENTION

It is to be understood that the figures and descriptions of the present invention have been simplified to illustrate elements that are relevant for a clearer comprehension of the present invention, while eliminating, for the purpose of clarity, many other elements found in systems and methods for assisted breathing. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Ranges: throughout this disclosure, various aspects of the invention can be presented in a range format. It should be understood that the description in range format is merely for convenience and brevity and should not be construed as an inflexible limitation on the scope of the invention. Where appropriate, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Referring now in detail to the drawings, in which like reference numerals indicate like parts or elements throughout the several views, in various embodiments, presented herein is a distension device, system and method.

Embodiments described herein include a distension device that, in some embodiments, may be attached to a patient's chest or abdomen to lift it outwards by way of one or more inflatable tubes that expand longitudinally more than they do radially, and in certain embodiments while maintaining a substantially constant diameter. Advantageously, the devices may contact a large surface area of the patient's chest and may also fit the various contours of patients that are encountered in practice, providing a stable and evenly distributed negative distending pressure to the patient. As a result, the devices described herein may pull outwards on a larger surface area with less concentrated stresses, leading to, for example, greater tidal volumes in a patient's lungs. By implementing inflatable tubes that lengthen with little to no change in diameter, the external ventilator devices also avoid the application of damaging compressive forces on the patient when inflated. In certain embodiments, a compressive force may be applied to the patient's chest to encourage a forced expiration (such as a cough) by creating a vacuum or negative pressure in the tubes, thereby shrinking them against the sides of the chest. Accordingly, the device may act as a chest expander and compressor by increasing the intraluminal pressure applied to the tubes (acting as a chest expander, applying a negative distending pressure) or decreasing the intraluminal pressure applied to the tubes (facilitates chest compression, applies a positive compressive force). Table 1 illustrates these two modes according to one embodiment.

TABLE 1

| Intraluminal Tube | Intrathoracic (Intrapleural) | Patient Respiratory |
|---|---|---|
| Pressure | Pressure Direction | Effect |
| Positive | Negative | Inhalation |
| Negative | Positive | Exhalation |

Additionally, a constant positive intraluminal tube pressure may be used to apply a static pressure, such as a static negative distending pressure to the subject's chest or abdomen for a predetermined period of time

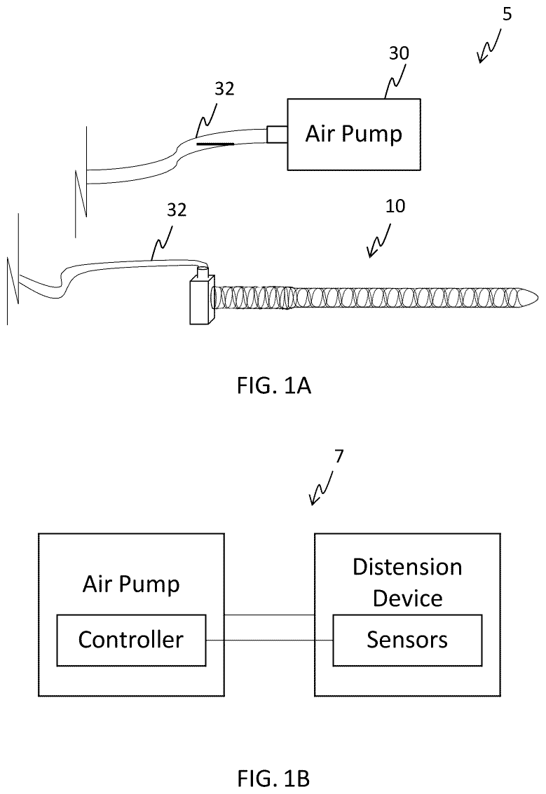

With reference now to FIGS. 1A and 1B, according to one embodiment, a distension system 5 includes a distension device 10 that is connected to an air pump 30 by a flexible connection tubing 32. The air pump 30 can be controlled by a controller that's connected to or integrated with the air pump 30. The air pump 30 drives air to a lumen of the distension device 10, generating a positive intraluminal pressure and causing the distension device 10 to expand longitudinally, as will be explained in further detail below. The controller can be connected wirelessly to a device controlled by the subject and/or a medical professional for reviewing air pump performance, observing sensor data from sensors integrated into the distension device, or changing setting or operating modes of the distension device. The sensors can be connected to a controller via a hardwired or wireless connection. In certain embodiments, the sensors can provide feedback to the controller regarding for instance the movement of the patient's diaphragm. The sensor feedback loop can automatically change the operating parameters of the air pump 30, for instance, changing the amplitude or intensity of an oscillating mode, or changing from an oscillating mode to a static mode. Sensors may include, for example EKG or RIP (respiratory inductance plethysmography) sensors. Sensors may be used to measure physiological parameters from the patient, and/or functional parameters of the distention device 10.

In one embodiment, the air pump 30 is portable and battery powered. In one embodiment, the air pump 30 is a self-contained compressor or a blower type pump. The subject may in certain embodiments wear the air pump 30 on a belt for added portability. In certain embodiments, the air pump 30 is a hand operated or foot operated pump. In certain embodiments, the air pump 30 supplies air to more than one distension device or more than one tube on a distension device 10. The air pump 30 also has functionality in some embodiments to generate and maintain a constant positive or negative pressure, using for example a system of valves. In certain embodiments, the air pump 30 oscillates between two different positive pressures, or between a positive and a negative pressure. A valve (such as a venturi valve) may be utilized to open and close for generating negative or positive pressures, or for oscillating between positive and negative pressures. For oscillation modes, the air pump 30 may provide high frequency increases in pressure of variable amplitude when required. Embodiments of static and oscillating pump modes are provided in further detail below. As would be understood by those having ordinary skill in the art, various types of pumps and pressuring media may be used to pressurize the tubes. For example, gas (e.g. Co2, helium) or liquid (water) may be used as a pressurizing fluid. Further, the media can be heated or cooled as needed for optimizing function of the tubes and providing a therapeutic effect to the patient.

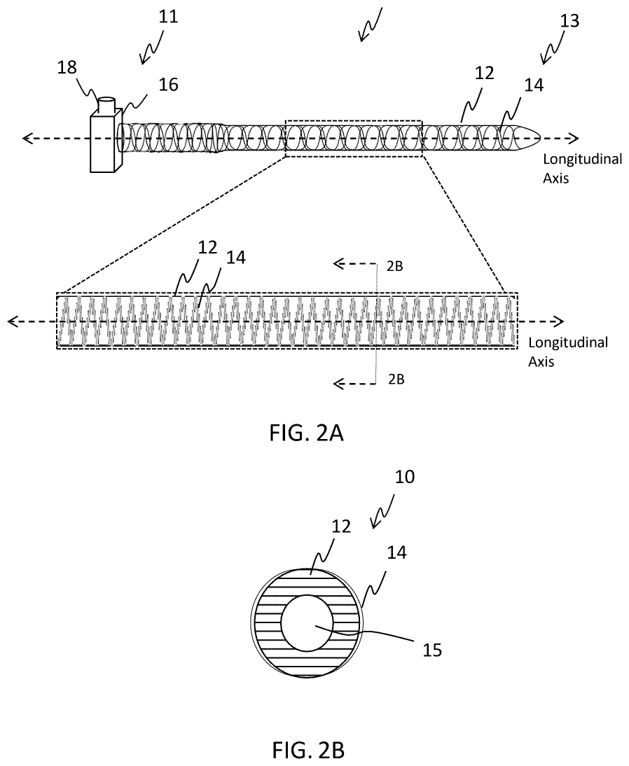

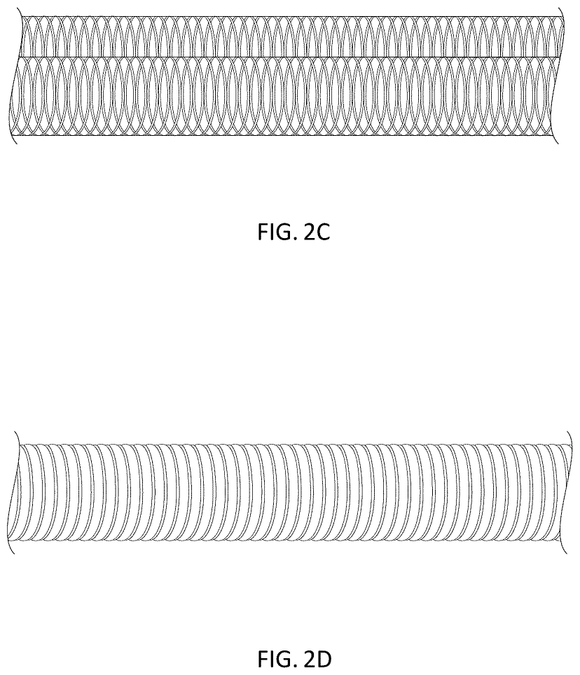

With reference now to FIGS. 2A and 2B, according to one embodiment, a distention device 10 is shown having an elongate flexible and elastic tube 12 extending along a longitudinal axis. The tube 12 has a number of restricting fibers or wires 14 wrapped around it in a pattern that prevents radial expansion. In one embodiment, wrapping the fiber reinforcements 14 in a symmetrical double-helix configuration prevents the tube 12 from expanding radially, so that it can only expand axially. Many configurations such as a single or double helix may be used to prevent or minimize radial expansion. In one embodiment, an additional layer of material is added to one side of the tube 12 to bias the movement of the tube 12 outwards and away from the patient's body during inflation. The fibers 14 can wrap around the tube 12 at an angle substantially perpendicular to the longitudinal axis in certain embodiments. The fibers 14 can be situated on the outside of the tube 12, within the wall of the tube 12, or along the inner wall of the tube 12. The fibers 14 can be arranged for example in a helix (e.g. FIG. 2C), double helix (e.g. FIG. 2A), rings or a combination thereof. The angle and/or density of the helical turns around the tube 12 can vary as desired to provide variable stretching characteristics along the length of the tube 12. In certain embodiment, variable stretching characteristics are achieved by varying the thickness of material, or otherwise varying the material geometry or chemistry. Shape memory material can also be used in the tubing material. For instance, shape memory materials can be used to ensure that the tube 12 maintains a convex curvature and does not form a concave curvature that could otherwise push it into the chest instead of away from it upon expansion. Shape memory materials can also be used to ensure that the tube 12 returns to the same shape and length when it returns to a relaxed state from the expanded state. In certain embodiments, instead of fibers 14, reinforcement can come from rigid or semi-rigid materials formed into a helical or ring pattern. In certain embodiments, elongation can be achieved by stretching the material of the tube 12, or alternatively by forming convolutions in the wall of the tube 12 (see e.g. FIG. 2D), such as those found in corrugated tubing.

In one embodiment, a distal end 13 of the tube 12 is closed, so that as air fills the lumen 15 of the tube 12, the pressure within the lumen 15 may expand the tube 12 longitudinally. A proximal end 13 of the tube 12 is open to the air supply port 18 which extends through the connection element 16 and is in fluid communication with the lumen 15. Non-limiting examples of elastic materials that may be included in the construction of the flexible and elastic tube 12 include silicone, vinyl, neoprene, polyvinyl urethane (PVC), urethane, and the like. In certain embodiments, the connection element 16 may be made from silicone. In one exemplary embodiment, the tube 12 has a length of approximately 17 cm elongated by approximately 3.5 mm (2%) at a pressure of 400 mmHg without a substantial change in diameter. In another embodiment, the distal end 13 of the lumen 15 is open to a second air supply port 18 that extends through a second connection element 16. Thus, certain embodiments of the invention can have multiple air supply ports 18, such as a first proximal port and a second distal port. One or both of the ports 18 can extend through the connection element 16.

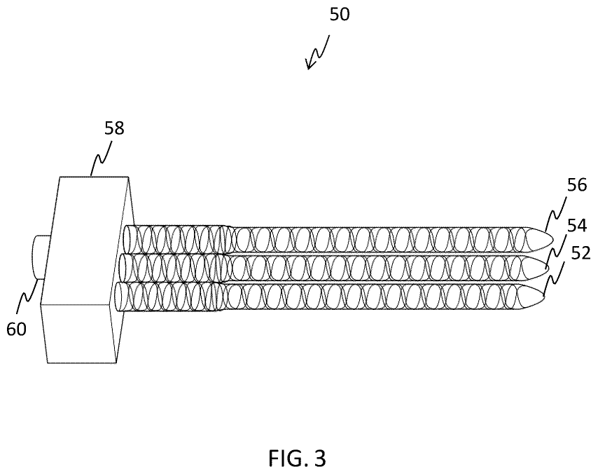

With reference now to FIG. 3, in one embodiment, the distending device 10 has three tubes 52, 54, 56. A connection element 58 has an air supply port 60 that branches to lumens of each of the three tubes 52, 54, 56. One advantage to this embodiment is that the additional tubes increase surface area contact with the skin. Lifting the chest or abdomen across a larger surface area decreases spot stresses that can occur with conventional systems that only contact the skin at a limited number of points. Patients that are taller or otherwise have an elongated midsection can also benefit from embodiments featuring additional tubes. Embodiments can include 2, 3, 4, 5, 6, 7 or more tubes. In certain embodiments, two or more tubes have independent air supply ports 60 extending through the connection element 58, and their air supply is independently controlled.

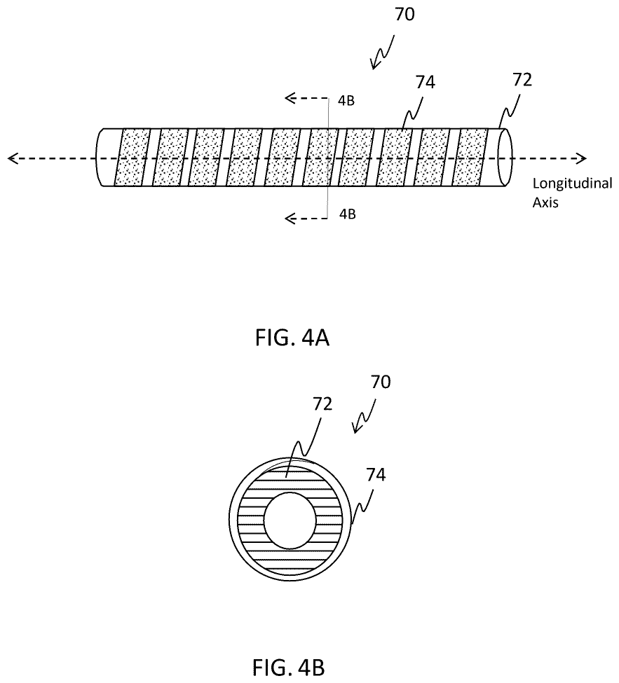

The flexible and elastic tubing may be restricted in radial expansion using various techniques as will be apparent to those having ordinary skill in the art. As described above, reinforcing fibers 14 can be used to restrict radial expansion and allow longitudinal expansion. In another technique, a fastening element used to attach the tube to the skin is applied to the tube such that it restricts radial expansion and allows longitudinal expansion. With reference to FIGS. 4A and 4B, in one embodiment, a distention device 70 has a flexible and elastic tube 72 that is restricted from expansion in the radial direction by a mating fastener 74, such as a hook and loop fastener. Thus, in this example, the fastener 74 could be the loop side of the hook and loop fastener, while the hook side of the fastener is attached to the patient. Various types of flexible mating fasteners known in the art can be adapted for this type of embodiment. In certain embodiments, longitudinal expansion is made variable, such as more expansion towards the center to lift the sternum up and less expansion on the sides so that the chest is not pulled as far out sideways. Variable expansion can be manipulated for example by varying the amount or pattern of fiber reinforcements, or for example by manufacturing a tubing with variable elasticity along its length.

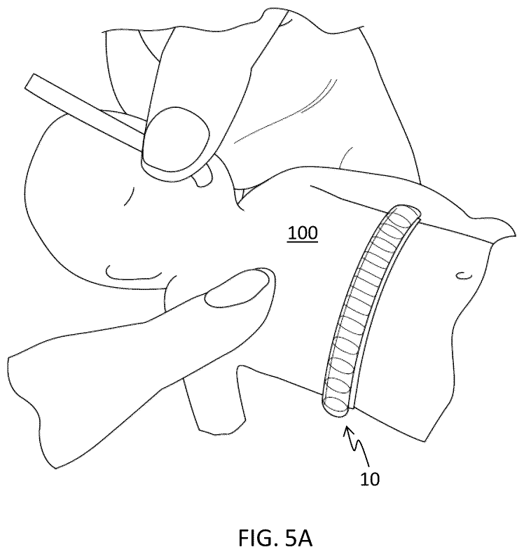

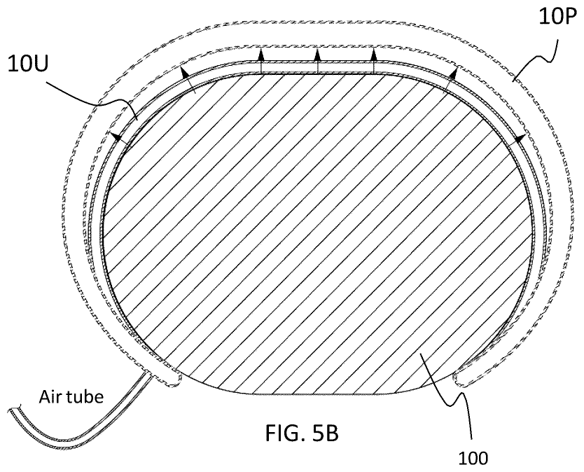

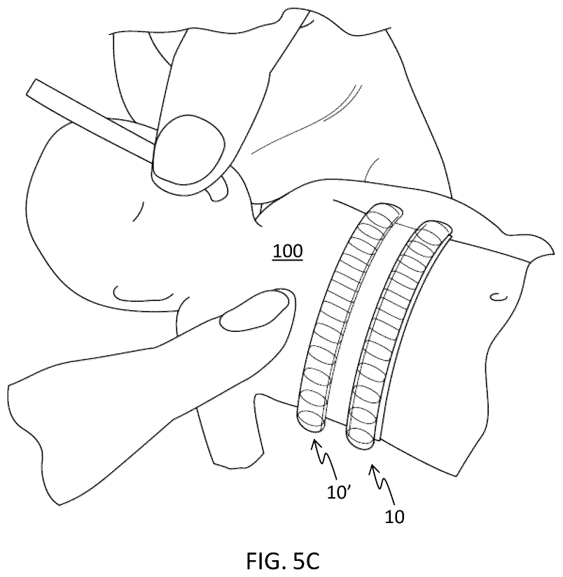

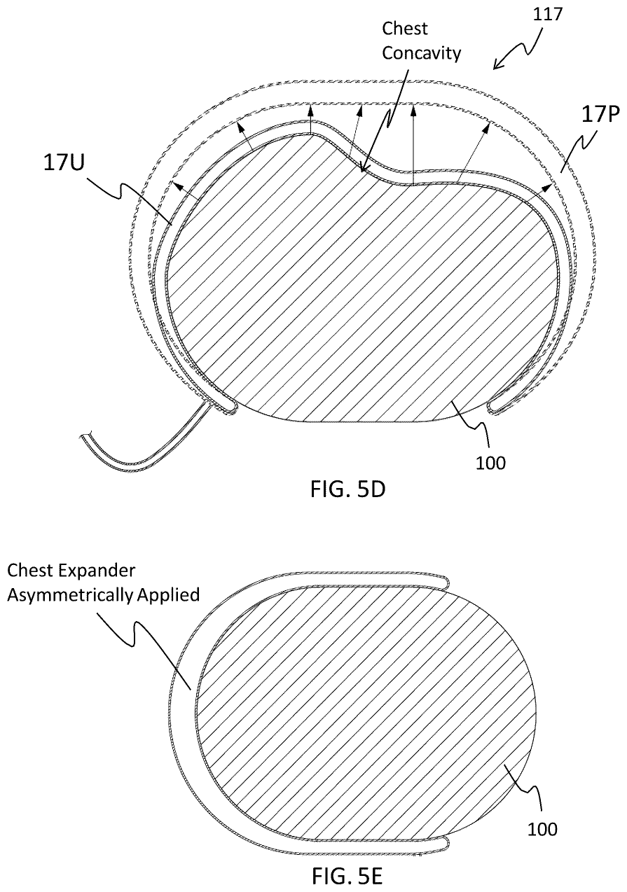

With reference now to FIGS. 5A and 5B, an exemplary embodiment of a distension device 10 is depicted as being placed around the body 100, for example, chest of an infant. When the device 10U is unpressurized as shown in FIG. 5B, it attaches to and follows the contours of the body (e.g. a collapsed chest). Pressurizing the tube 10P causes it to elongate longitudinally and naturally it raises up and outwards, distending the chest wall thereby applying a negative distending pressure to the chest. Generally, the primary mode of operation of the distension device 10 is to pull outward on the chest wall as the tube tries to longitudinally expand its volume when pressurized. This in turn causes distension of the chest wall and an increase the volume of the chest, and thereby, the lungs. In certain embodiments, the force acts outward if the relaxed curvature of the chest is convex. In certain embodiments, if the chest has a concavity, a plate, filler or other similar type support can be adhered across the concavity so that the tube 12 remains convex in the unpressurized or relaxed position. In certain embodiments a vacuum pressure can be applied to the tubes 12 which will then compress the chest wall creating a forced exhalation.

More than one distension device 10, 10′ can be included in a system that controls multiple distension devices, as shown for example in FIG. 5C. Systems that control multiple distension devices can be controlled by a controller operably connected to the first and second distension device 10, 10′. In one embodiment, the controller is configured to independently drive the expansion of the first and second distension devices 10, 10′. In one embodiment, the controller is configured to oscillate inflation of one distension device while providing a constant inflation to the other distension device. In one embodiment, the controller is configured to oscillate inflation of one distension device and oscillate inflation of the other distension device. The oscillations can be centered around different average pressures. In one embodiment, the oscillations are out of sync such that one distension device pulls out from the body while the other device either moves back towards the body or remains statically pulled away from the body.

With reference now to FIG. 5D, the distension device 117 is depicted as being placed around the chest of an infant having a chest concavity. When the device 117 is unpressurized 17U, it attaches to and follows the contours of the body (e.g. a collapsed chest having a chest concavity). A filler material (e.g. foam or padding) may be applied in the concavity and adhered to the skin and chest expander to maintain the chest expander in a convex shape. Pressurizing the tube 17P causes it to elongate longitudinally and naturally it raises up and outwards, distending the chest wall thereby applying a negative distending pressure to the chest. The tube can have variable or customized properties for patients with a concavity so that the tube when extended moves the chest in the correct direction for applying a negative distending pressure. With reference to FIG. 5E, the length of the tube can vary to selectively direct the area of the chest wall the practitioner wants to treat. In one embodiment, the tube is shortened, or only a portion of the tube is applied to the body 100 in an asymmetric fashion. In one embodiment, the tube is connected to only one side of the chest. In one embodiment, a property of the tube such as elasticity is varied or restrained along a specific portion of the tube to provide a specific asymmetrical and targeted distension and/or compression. In one embodiment, the tube is connected to both sides of the chest, each covering only half the circumference of the chest. For example, if the patient has a fractured rib on one side, the practitioner could apply a device 117 with shorter tubes that served to provide external stabilization of the ribcage to a more focal area, and each side could operate separately. Stabilization would reduce pain and help healing while allowing the chest wall to function better. In one embodiment, ends of the tubes can be fixed to the skin over the sternum and over the midline of the back (see e.g. FIG. 5E). In one embodiment, the adhesive can be applied evenly to the under surface of the tubes, or unevenly so as to allow the skin to breathe and release humidity (sweat) as needed. The introduction of gaps or spaces between applications of adhesive may promote breathing of the skin.

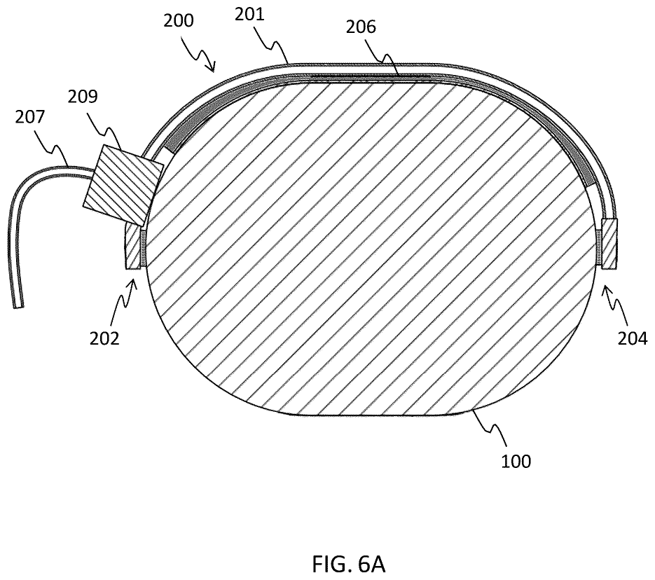

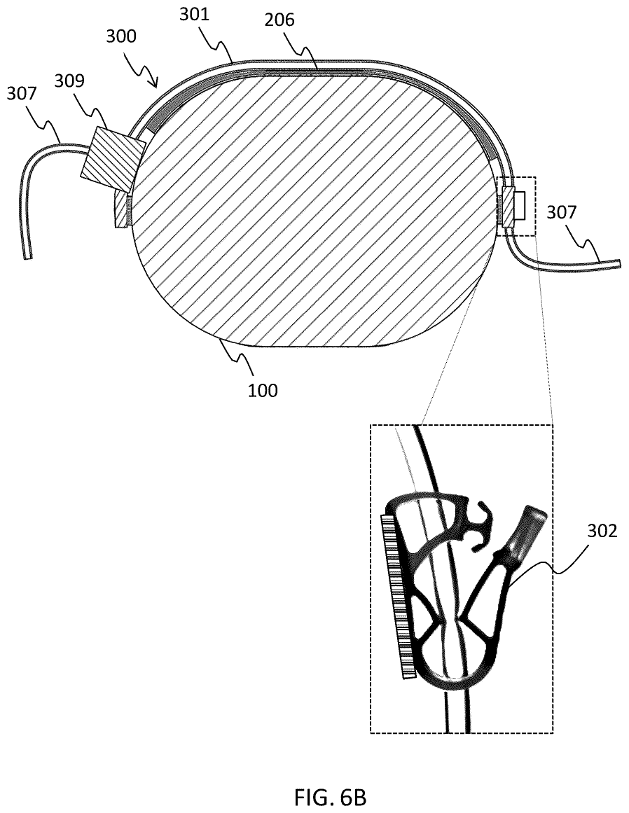

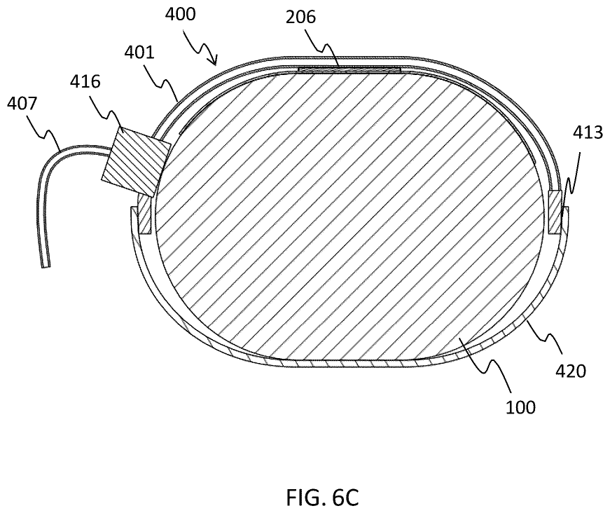

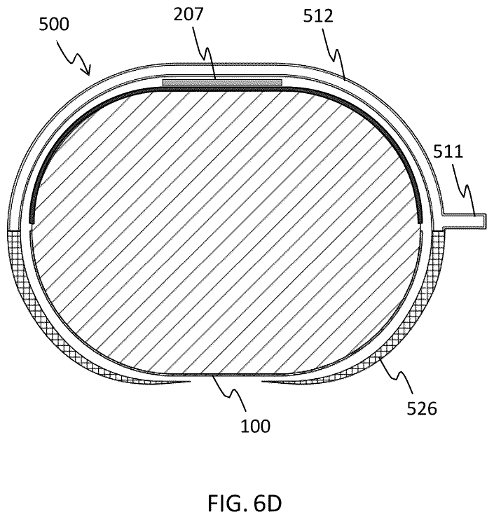

Various means for securing the distension device to the patient are depicted in FIGS. 6A-6D. FIG. 6A depicts an exemplary distension device 200 anchored to a first 202 and second 204 posterolateral or posterior region of the patient. The tube 201 is connected to a connection element 209 housing a port that communicates air between the air supply 207 and the tube 201. The tube 201 is adhered to the patient by a fastening element 206 such as an adhesive. In one embodiment, the device 200 includes an adhesive 206 for attaching the tube 201 to a surface of the subject. In some embodiments the device 200 may have more than one tube 201. In one embodiment, the adhesive 206 in an elongate strip maintains continuous contact with the skin along the length of the strip. In some embodiments, the adhesive 206 may include a silicone adhesive such as SILBIONE Silicone RT Gel 4317 or similar Silicone Gels of varying adhesive quality, hydrogel or a hydrocolloid dressing, such as DUODERM, COMFEEL, or COLOPLAST hydrocolloid pectin compounds, which can be removed with water without epidermal stripping. In another embodiment, the fastening element 206 may include a semi-permeable membrane dressing, for example a thin layer of TEGADERM medical dressing. In another embodiment the fastening element 206 can be any adhesive or other type of compound suitable for contacting a patient's skin and also suitable for bonding fastening strip to the patient's skin.

In one embodiment, the fastening element 206 may be a patch that can protect the patient's skin and provide a surface for adhering the tube 201 or tube assembly. In one embodiment, the fastening element 206 may include a release liner layer, a hydrogel layer, or some other type of skin protective layer, and an outer layer for adhering the tube. In such an embodiment, the release liner layer can be removed to expose the silicone or hydrogel layer for attachment to the patient's skin. Further, in such an embodiment, an outer layer may comprise a suitable material, such as polyurethane, that includes VELCRO hook attachment portions for attaching a matching VELCRO loop portion that is part of, or otherwise attached to, the tube 201. Preferably, the adhesive 206 is applied in a pattern that enables deformation compatible with linear expansion of the tube 201, such as a zig-zag pattern. In certain embodiments, the adhesives 206 are constructed in a pattern that does not enable deformation. In certain embodiments, the adhesive 206 on the posterolateral aspect of the chest does not allow stretching but the adhesive 206 (e.g. Velcro) on the front and anterolateral aspect of the chest may allow stretching by being cut in a zig zag fashion.

FIG. 6B depicts an exemplary distension device 300 secured to the body 100 similarly to that of FIG. 6A. The tube 301 is connected to a connection element 309 housing a port that communicates air between the air supply 307 and the tube 301. Since various length of the device 300 tubing would be desirable depending on the characteristics of the patient and the condition being treated, a clamp 302 (shown open) may be included so that the distal end of the device is clamped off where desired. The clamp 302 can be integrated onto the anchor as depicted. FIG. 6C depicts an exemplary distension device 400 secured to a body 100 by way of a restraining strap 420. The tube 401 is connected to a connection element 416 housing a port that communicates air between the air supply 407 and the tube 401. The restraining strap 420 connects to the connection element 416 and the closed end 413 of the tube 401. The restraining strap 420 can be connected in any suitable manner as would be understood by a person skilled in the art, including, but not limited to a snap button, clip, buckle, and the like. The restraining strap 420 is positioned on a patient such that when the patient is lying in a supine position, the restraining strap 420 is held between the patient's back and the structure underneath.

FIG. 6D depicts an exemplary distension device 500 secured to a body 100 by way of tube extensions 526. The tube extensions 526 are extensions of the at least one tube 512. The tube 512 is connected to a connection element 511 having a port that communicates air between an air supply and the tube 512. In certain embodiments, the tube extension 526 is a solid material that is non-inflatable. In certain embodiments, the tube extensions 526 overlap and attach to each other to help secure the distension device 500. The tube extensions 526 may be tampered and may serve as a connector port for the inflating air. In certain embodiments, a non-inflatable portion is used for anchoring to the posterolateral aspects of the chest wall. In certain embodiments, the Velcro under the non-inflatable portions is continuous and will not permit elongation-just anchoring. In certain embodiments, silicone adhesive may be used and may permit some stretching as needed by the patient when the patient takes a deep breath. In contrast, the Velcro under the inflatable portion of the tube 512 may be cut in a zig-zag or Z-shaped configuration to permit stretching in response to the tube 512 as it elongates. The silicone adhesive under the inflatable portion of the tube (tube assembly) allows stretching of the tube 512 assembly. Another embodiment includes an air inlet port included in a silicone connector that also serves to allow attachment of the tubes 512, and provides a fixed connection to the chest wall. One of these connectors can be included at both ends so that the tube 512 could be trimmed to custom fit. In certain embodiments, the connectors would have a mechanism (see for example the connector of FIG. 6B) for clamping both ends of the tube 512 in a way that was airtight and resistant to the pressure build up within the tube.

In some embodiments, the device 500 may maximize surface area contact to include the front and sides of the chest wall and be easily adaptable to patients having a variety of body surface contours, shapes and sizes. In some embodiments, the device 500 is adaptable for children and adults that require or could benefit from mechanically assisted breathing.

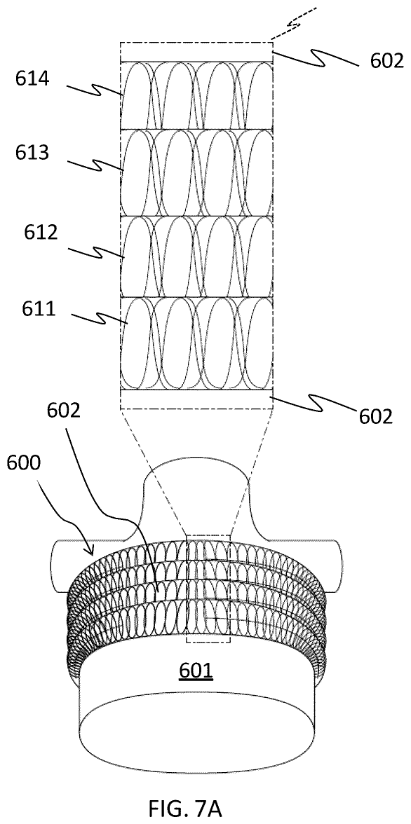

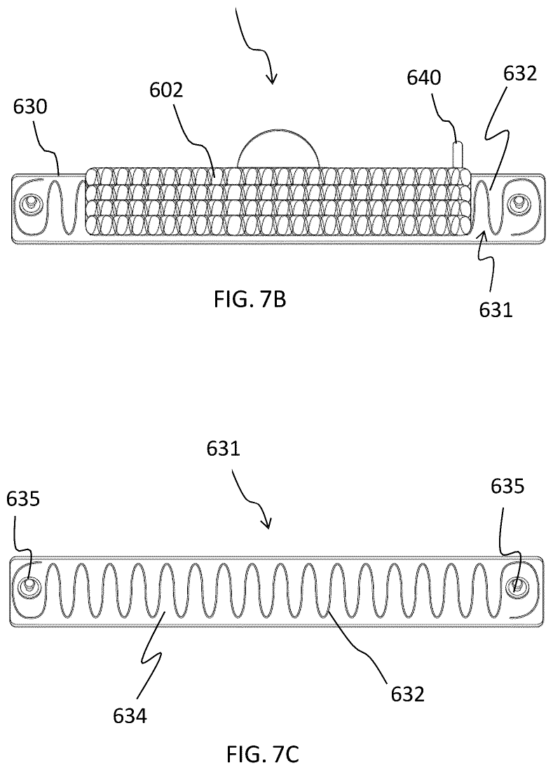

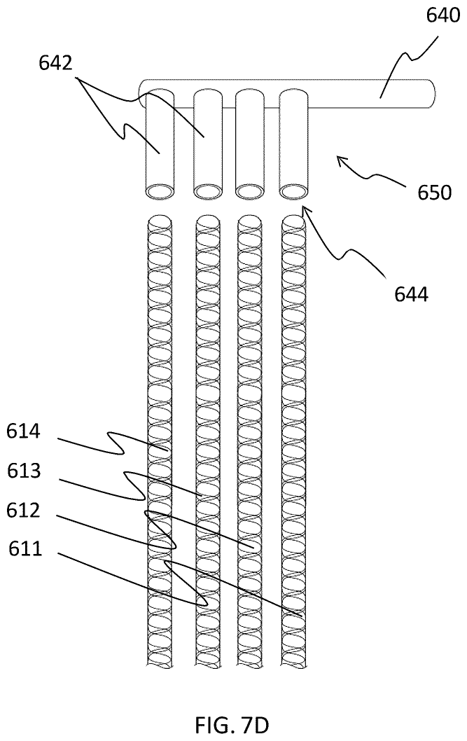

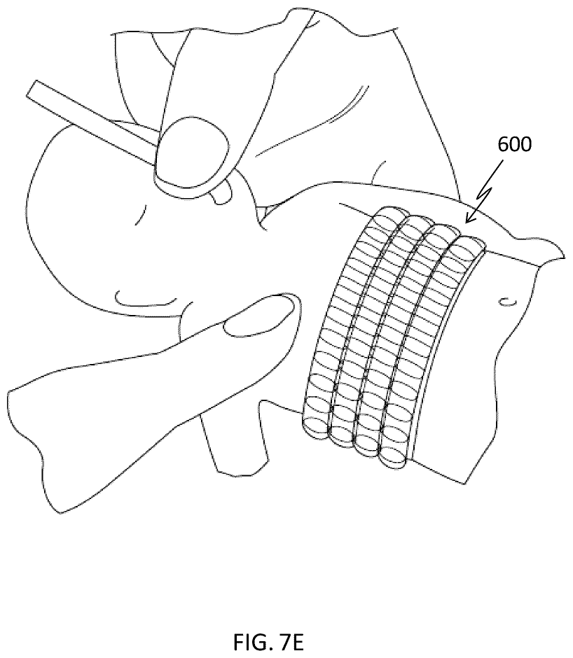

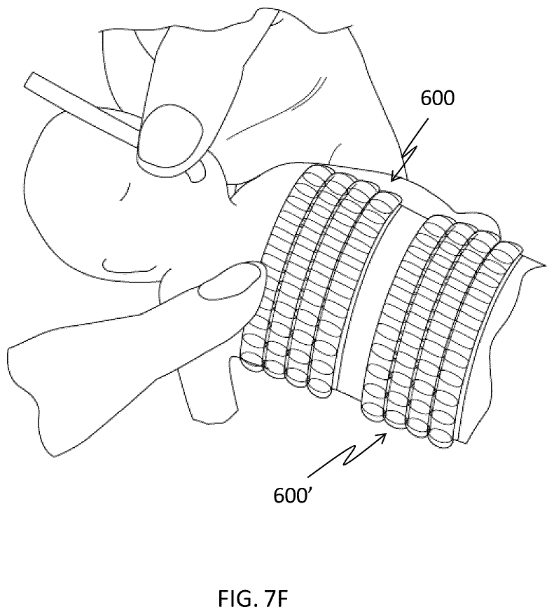

With reference now to FIG. 7A, a chest expander 600 is shown according to one embodiment as having four longitudinally expandable tubes 611, 612, 613, 614 embedded in silicone 602 (as shown in magnified partial cutaway view 620), which advantageously increases the surface area contact with the patient. The silicone 602 should be sufficiently elastic and flexible so that it can assume the shape of the patient's chest or abdomen, and also mirror the expansion described herein for the longitudinally expandable tubes 611, 612, 613, 614. In certain embodiments, the tubes 611, 612, 613, 614, are only partially embedded into the silicone. In certain embodiments, silicone is added to gaps between the tubes 611, 612, 613, 614, for connecting the tubes and increasing surface area contact with the patient. In certain embodiments, the tubes 611, 612, 613, 614, are configured to expand at different rates or to different distances depending on the preferred expansion profile of the chest expander 600, the characteristics of the patient, and the type of treatment being administered. This can be accomplished for example by varying individual tube characteristics, varying the pressurizing medium, and/or varying the amount of pressure delivered to individual tubes.

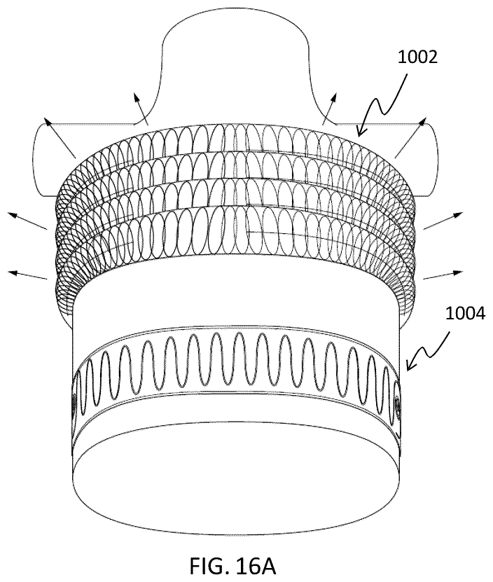

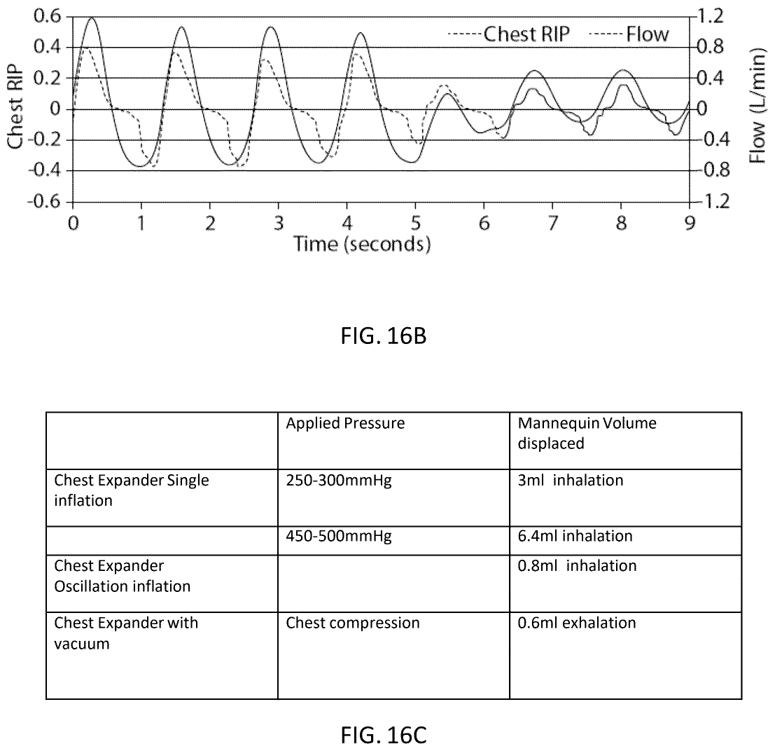

With reference now to FIGS. 7B and 7C, in one embodiment the chest expander 600 can have a layer including a silicone plethysmography sensor 631, including a sinusoidal wire 632 embedded in in the silicone with snap connectors 635 at either end. The under surface of the silicone plethysmography sensor 631 may be covered with a silicone adhesive strip 630 or backing having a release liner, such as a peel-and-stick adhesive backing. The silicone skin adhesive can also be provided in liquid form and may be directly applied to the patient side of the Chest expander 600 and then cured. The sinusoidal wire 632 in certain embodiments is partially or fully embedded in a silicone layer 634. The sensor 631 may be used to measure how the chest and/or abdomen moves with breathing. The sensor 631 expands on inspiration and is an example of a sensor that can be used to generate a feedback signal for controlling and automatically adjusting the output of the pump. The sensor 631 may be integral to the chest expander 600, or positioned separately (see e.g. sensor 1004 in FIG. 16A). The sensor 631 or adhesive strip 630 may have additional connectors 635 such as Velcro, snap, adhesive or button connectors for connecting ends of the strip together. As shown in FIG. 7D, components of the chest expander 600 may include a connection element 650 that in one embodiment includes a primary air conduit 640 for connection to an air supply, and branched connections 642 that receive air from the primary air conduit 640 and connect to the longitudinally expandable tubes 611, 612, 613, 614. The connection element 650 may include one or more valves such as pressure actuated or controller actuated valves for simultaneously or individually controlling air flow to one or more tubes 611, 612, 613, 614. The branched connections 642 may also be sized to selectively control air flow to individual tubes. The chest expander 600, like other embodiments, can be placed on the chest (FIG. 7E) with an additional expander 600′ placed on the abdomen (FIG. 7F).

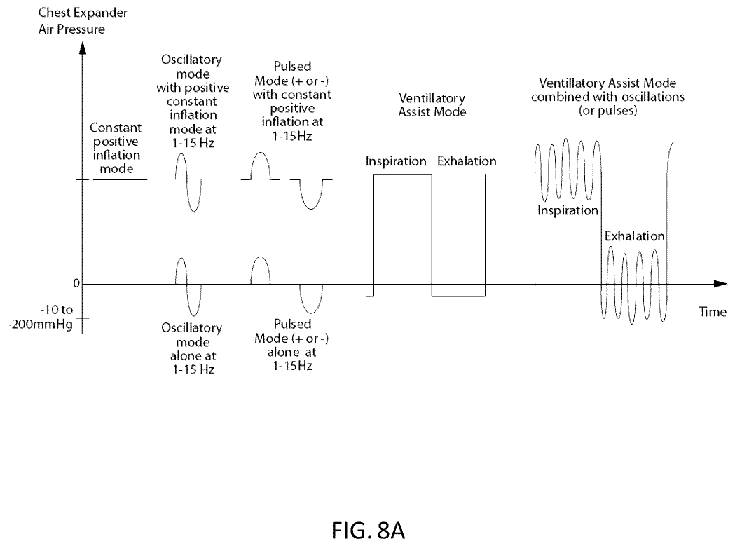

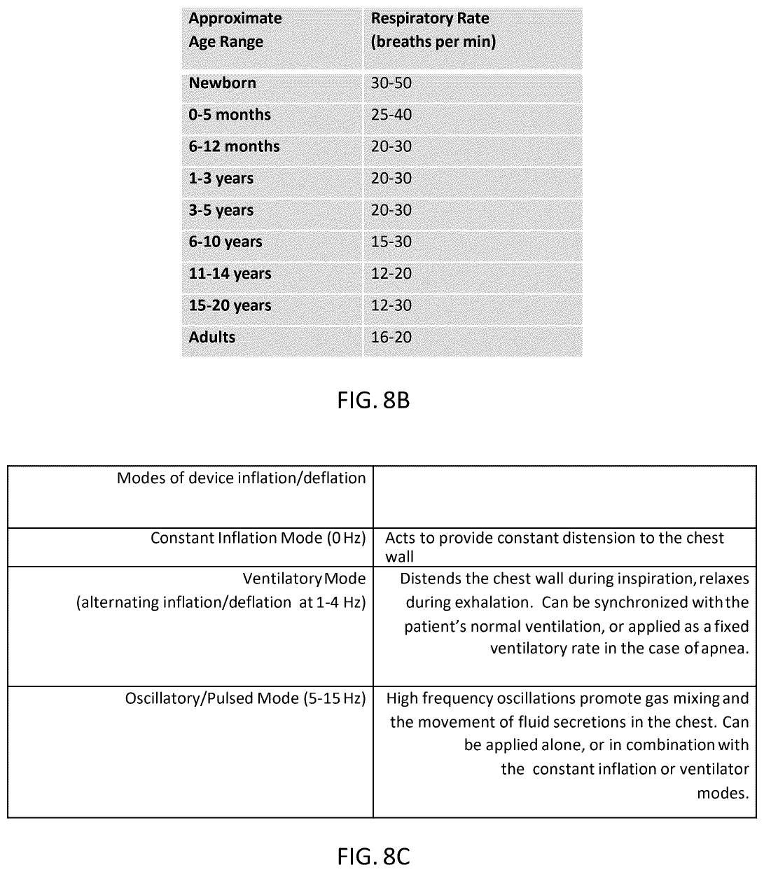

With reference now to FIG. 8A, various oscillation modes are shown. In one embodiment, a constant positive inflation mode maintains a constant positive pressure. This acts to provide a constant distention to the chest wall. In one embodiment, an oscillatory mode oscillates at 1-15 Hz between two positive pressures or between a positive and a negative pressure or even just a negative pressure. Thus, embodiments described herein can cause the device to exert a negative distending pressure to the chest wall and a positive compressive pressure to the chest wall. In one embodiment, a pulsed mode pulses between two positive pressures (producing chest wall expansion) or a positive and a negative pressure exerted to the chest wall. In another embodiment a pulsed mode pulses a negative pressure into the tubes thereby causing a compressive pressure on the chest. In one embodiment, a ventilatory assist mode maintains a positive pressure into the tubes during inspiration and a negative pressure into the tubes during exhalation. This distends the chest wall during inspiration, and relaxes it during exhalation. This mode can be synchronized with the patient's normal ventilation, or applied as a fixed ventilatory rate in the case of apnea. The inflation and deflation can alternate at about 1 to 15 Hz in some embodiments. In certain embodiments, the absolute value of pressure in the tubes at inspiration is much higher than the absolute value of pressure at exhalation. In one embodiment, a ventilatory assist mode combines with oscillations or pulses, oscillating around two positive pressures for inspiration and oscillating between a positive and a negative pressure during exhalation. Oscillations or pulses in certain embodiments are between 1 and 15 Hz. High frequency oscillations promote gas mixing and the movement of fluid secretions in the chest. This mode can be applied as a standalone mode, or in combination with the constant inflation or ventilator modes. Setting can be adjusted based on the patient, and one embodiment of guidelines for respiratory rates is provided in the table shown in FIG. 8B. These are normal respiratory rates. High frequency ventilation will require higher rates (1-15 Hz) that produce smaller volumes than usual tidal volumes. Exemplary modes of device inflation/deflation are summarized in the chart shown in FIG. 8C.

The degree of outward pull provided by the device can be adjusted based on the amount of air in the tube. For example, the distending pressure in the tube can be controlled by increasing the amount of air added to the tube, or by removing air from the tube. This allows the operation of the device to be fine-tuned, allowing for relatively small, and thus safe, adjustments of negative distending pressure on the patient's chest. In various embodiments, a clinician can adjust the pressure into the tube using a pressure controller so as to obtain only slight chest movement and prevent over-distension of the lung. In one embodiment, the operation of the device can be fine-tuned by using a ventilation device useful for measuring air pressure, such as a NEOPUFF device. When using the NEOPUFF device, a clinician can adjust the amount of continuous airway pressure delivered to the tube instead of to a face mask or endotracheal tube. In another embodiment, the operation of the device can be controlled by using a syringe with volume indicators. In one such embodiment, the tube can be optimally inflated with a syringe or a self-inflating bag with a one-way valve. In another embodiment, the tube may be inflated using airflow with pressure regulated by a connection to a tube submerged under water so the pressure delivered to the tube would bubble at the set height of the water column. This method of inflating the tubes can provide negative distending pressure as well as chest wall oscillations produced by the bubbles. In such an embodiment, the height of the water column may regulate the amount of inflation. In addition, the inflation of the tube can be synchronized with spontaneous breathing by the patient, as detected by abdominal movement, or mechanical or electrical detection of diaphragmatic movement, i.e., NAVA ventilation.

Other sensors may include for example thoracic impedance sensors and chest wall accelerometers. In one embodiment, the device of the present invention can be used in conjunction with a MAQUET SERVO-i ventilator and may make use of the NAVA catheter that senses the electrical activity of the diaphragm. In one embodiment, the abdominal movement is detected by one or more sensors positioned on the device. In one embodiment, the device is used with or integrated into a respirator. In another embodiment the device can be used to embed sensors for monitoring physiological changes that include, chest motion, EKG, and respiratory and cardiac sounds.

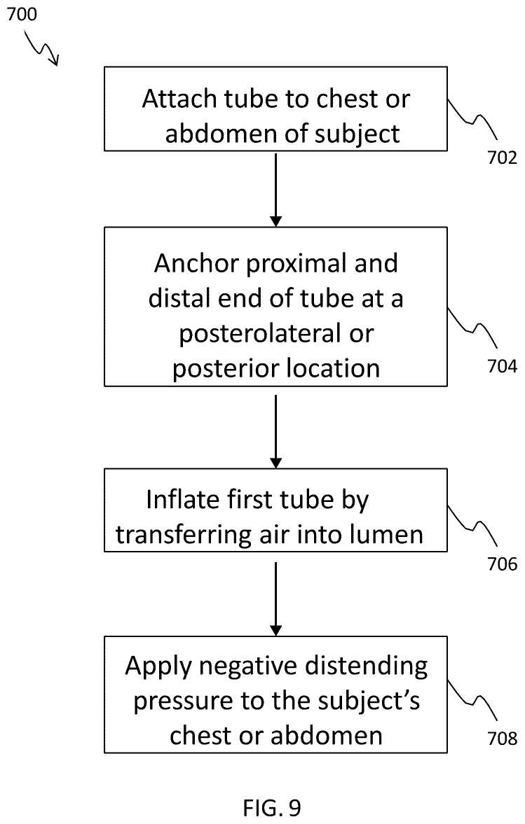

A method 700 for assisting a patient's breathing is also disclosed, with reference now to FIG. 9. In one embodiment, the method 700 includes the steps of attaching a first flexible and elastic tube having a first lumen to the chest or abdomen of a subject (step 702), anchoring a proximal and distal end of the at least first tube to a first and second posterolateral or posterior region of the subject (step 704), inflating the at least first tube by transferring air into first lumen (step 706), and applying a negative distending pressure to the subject's chest or abdomen via the inflating (step 708). In one embodiment, the at least first tube may be at least partially deflated to reduce the negative distending pressure applied to the subject's chest or abdomen. In one embodiment, the at least first tube is attached to the subject's chest or abdomen by a skin attachment mechanism. In one embodiment, the skin attachment mechanism is a hydrogel. In one embodiment, the skin attachment mechanism is a hydrocolloid. In one embodiment, the skin attachment mechanism is a semi-permeable membrane dressing. In one embodiment, the at least first tube is in continuous contact with the subject's chest or abdomen. In one embodiment, the method may include transferring air into the first lumen via a syringe or a bulb syringe. In one embodiment, the method 700 may include transferring air into the compartment via a ventilator or an air pump. In one embodiment, the method 700 includes transferring a predetermined amount of air into the compartment to inflate the at least one first tube. In one embodiment, the predetermined amount of air corresponds to an application of negative distending pressure to the subject's chest or abdomen (step 708) that causes the subject to inhale a breath approximately equal to or less than the tidal volume. In one embodiment, the inflation of the at least one tube is synchronized with the spontaneous inspiration of the subject. In one embodiment, the negative distending pressure applied to the subject's chest or abdomen (step 708) is statically maintained for a predetermined period of time. In one embodiment, the method may include deflating the at least one tube to release the negative distending pressure. In one embodiment, the inflating or deflating of the at least one tube is controlled based on sensor feedback of the subject's diaphragm. In one embodiment, the operation of the at least one tube is based on sensor feedback. In one embodiment, the step of applying a negative distending pressure (step 708) may include high frequency oscillations. In one embodiment, vacuum pressure is applied to the tube to generate a positive compressive force on the patient.

In some embodiments, a distension device may also include a flexible adhesive wrap that can be adhered around a limb. The wrap in certain embodiments consists of an assembly of hollow reinforced silicone tubes that when inflated elongate and when deflated shorten. This configuration provides the ability to provide both decompressive and compressive forces to the outside of the limb. The decompressive force is unique in that it can simulate the decompression achieved with a negative pressure chamber. Conventional devices cannot provide both decompressive and compressive forces. A pneumatic pump for providing intermittent pressure or vacuum to the wrap can be implemented as part of the system. A hand operated syringe pump may also provide inflating and deflating pressure to the tubes. The syringe may be used instead of the pneumatic pump and be attached to the air supply port or air inlet tube. In some embodiments, the distension device may apply compressive or decompressive pressure to limbs for the purpose of facilitating venous, lymphatic and arterial circulation. The compressive or decompressive force to the skin surface may be used to transfer a positive or negative pressure to the tissue below the skin. These forces influence the movement and distribution of body fluids including blood, lymphatics, or extracellular fluid to prevent edema, venous thrombosis or ischemia of the limb. This method is an alternative to creating biphasic (positive and/or negative) pressure in the air surrounding the limb. Embodiments described herein may provide a less cumbersome way to replicate the decompression effect delivered by conventional negative pressure chambers while providing a device that can accommodate more anatomical diversity with the ability to combine positive and negative pressure forces. Embodiments may consist of two primary components, a flexible and elastic tubular structure and a pneumatic driver.

For addressing vascular insufficiency of the extremities, application of decompressive and compressive forces to improve venous and arterial supply in a single device is unique. The wearable and modular approach provides a device that may be applied to different regions of the body for example but not limited to, the upper or lower leg or foot, making the point of application more versatile. Embodiments of the distension device may be used in the home or hospital setting for patients with, for example, impaired circulation of the legs (about 1 in 1000 individuals). This may include patients who have poor peripheral circulation as a side effect from medication used to treat low blood pressure and circulatory shock (e.g. dopamine). In the hospital setting, embodiments of the distension device may be used to prevent deep vein thrombosis in bedridden or post-surgical patients. Anesthesia (especially general or spinal) can increase DVT risk by reducing venous return and muscle tone during immobility. In hip or knee replacement surgery the incidence of DVT without any form of prophylaxis is 40-85%. Accordingly, the need to facilitate venous return is not limited to those patients with peripheral vascular disease.

Embodiments of the distension device may also have long lasting effects to improve blood flow, and thereby reduce the need for analgesics, vascular reconstruction, and/or amputation. Industry research has focused on devices for treating vascular insufficiency that focus on methods for providing intermittent compression to the limbs to prevent deep vein thrombosis. However, these conventional devices do not have methods for producing decompression and improving arterial supply. Embodiments described herein fit this need. In addition, conventional devices do not adhere directly to the skin.

With reference now to FIG. 10, in one embodiment, a distension device 800 includes a flexible and elastic tubular structure 802, which is a flexible and elastic component that wraps around a portion of the body 100, for example, a limb and adheres to the skin of the limb 100 via a skin friendly adhesive such as a silicone adhesive. The flexible and elastic tubular structure 802 changes shape and in turn transmits force directly to the tissue it's adhered to. The flexible and elastic tubular structure 802 can be applied in interconnected segments 802′, 802″ to desired regions of the limb 100, for example the thigh, lower leg, and foot. The second component is a pneumatic pump 820 for activating the flexible and elastic tubular structure 802. The pneumatic pump 820 may provide inflating or deflating pressures to the flexible and elastic tubular structure 802 intermittently as desired by the clinician. In FIG. 10 a leg with a first flexible and elastic tubular structure 802′ is wrapped around a lower leg and a second flexible and elastic tubular structure 802″ is wrapped around a foot. A third flexible and elastic tubular structure could for example wrap around the lower thigh just above the knee.

In some embodiments, the flexible and elastic tubular structure 802 includes an assembly of a plurality of flexible and elastic tubes 804 that are reinforced radially so that when pressurized they elongate without becoming wider. The tubes 804 may be one or more tubes. The tubes 804 may be made from, for example, silicon. The tubes 804 may have tubular structures similar, for example, to the tubular structures described in U.S. patent application Ser. No. 18/066,333 to Palmer et al, incorporated herein by reference. The tubes 804 in one embodiment are flexible and elastic, able to elongate and extend along a longitudinal axis. In one embodiment, each tube 804 may have a number of restricting fibers or wires wrapped around the tube 804 in a pattern that prevents radial expansion. In one embodiment, wrapping the fiber reinforcements in a symmetrical double-helix configuration prevents the tube 804 from expanding radially, so that the tube 804 may only expand axially. Many configurations such as a single or double helix may be used to prevent or minimize radial expansion. In one embodiment, an additional layer of material is added to one side of the tube 804 to bias the movement of the tube 804 outwards and away from the patient's body during inflation. The fibers may wrap around the tube 804 at an angle substantially perpendicular to the longitudinal axis in certain embodiments. The fibers can be situated on the outside of the tube 804, within a tube wall, or along an inner wall of the tube. The fibers may be arranged for example in a helix, double helix, rings or a combination thereof. The angle and/or density of the helical turns around the tube 804 may vary as desired to provide variable stretching characteristics along the length of the tube 804. In certain embodiments, variable stretching characteristics are achieved by varying the thickness of tube 804 material, or otherwise varying the material geometry or chemistry. Shape memory material may also be used in the material of the tube 804. For instance, shape memory materials may be used to ensure that the tube 804 maintains a convex curvature and does not form a concave curvature that could otherwise push it into the limb 100 instead of away from the limb 100 upon expansion. Shape memory materials may also be used to ensure that the tube 804 returns to the same shape and length when it returns to a relaxed state from the expanded state. In certain embodiments, instead of fibers, reinforcement may come from rigid or semi-rigid materials formed into a helical or ring pattern. In certain embodiments, elongation may be achieved by stretching of the tube 804 material, or alternatively by forming convolutions in the tube wall, such as those found in corrugated tubing.

In one embodiment, the distension device 800 has a distal end 830 and a proximal end 831. In some embodiments, the distal end 830 may be closed, so that as air fills the lumen of the tubes 804, the pressure within the lumen may expand the tubes 804 longitudinally. The proximal end 831 of the tubes 804 may be open to the air supply port 806 or inlet. Multiple tubes 804 may extend away from a proximal end branch 807 of the air supply port 806. Non-limiting examples of elastic materials that may be included in the construction of the flexible and elastic tube 804 include silicone, vinyl, neoprene, polyvinyl urethane (PVC), urethane, and the like. In one embodiment, the connection elements for example a proximal hook and loop surface 812 and a distal hook and loop surface 812′ may be made from silicone. In another embodiment, the distal end 830 may be open to a second air supply port that extends through a second connection element. Thus, certain embodiments of the invention may have multiple air supply ports, such as a first proximal port and a second distal port. In another embodiment, multiple air supply ports 806 or inlets will supply separate flexible and elastic tubular structures 802 thereby allowing sequential inflation and deflation of the tubes 804. For example, deflation of distal tube structures, the second flexible and elastic tubular structure 802″, (around the foot) followed by sequential inflation of more proximal tube structures, the first flexible and elastic tubular structure 802′, (around the calf) will facilitate venous return thereby relieving venous stasis.

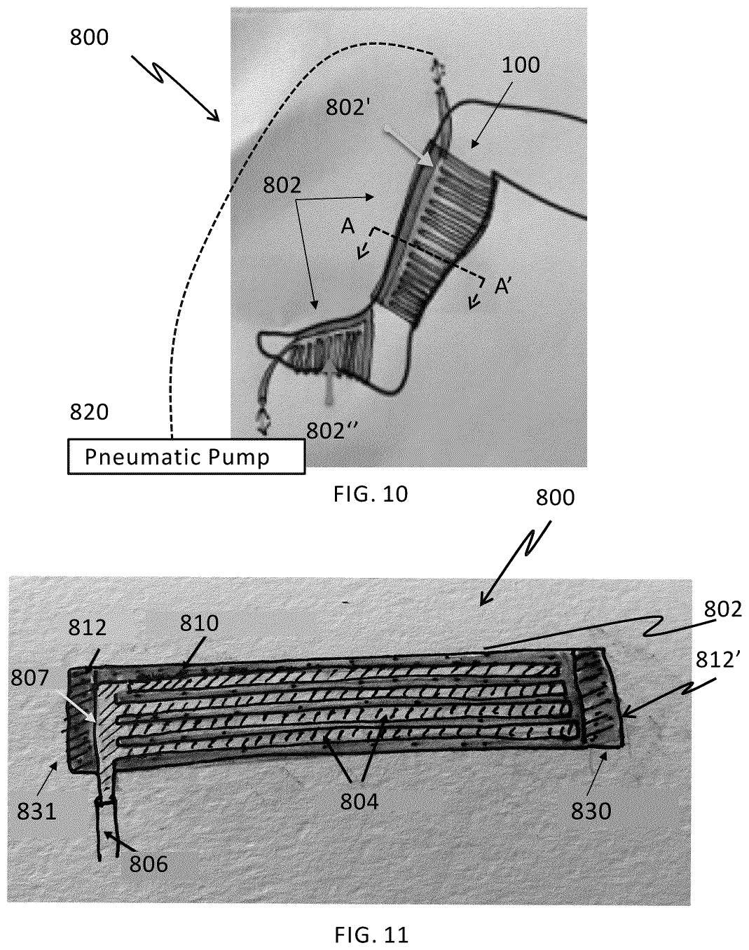

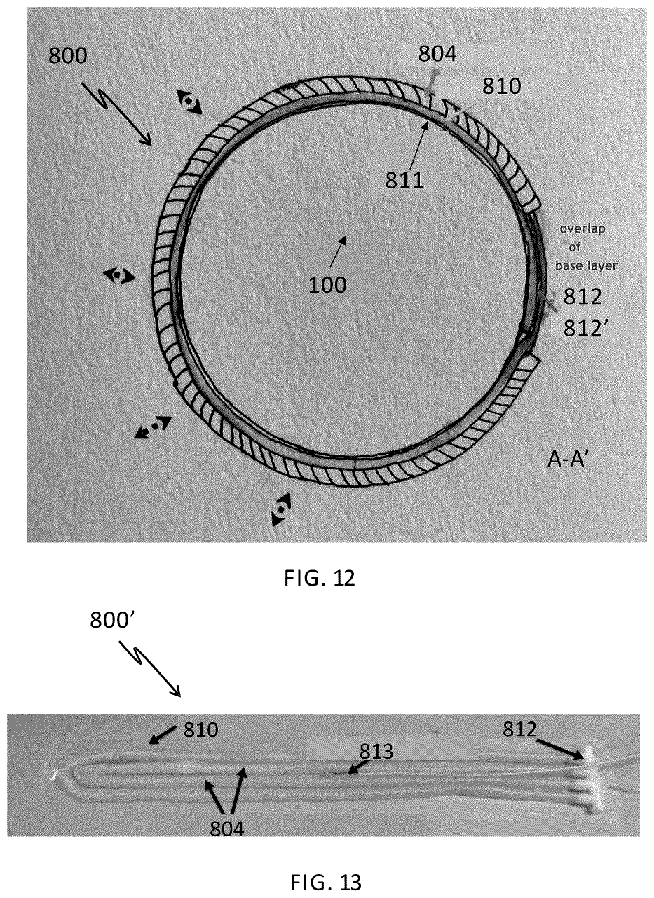

With reference now to FIGS. 11-13, the tubes 804 are embedded alongside each other in a base layer 810, that may be thin and may be made from silicon, to form a band of varying widths depending on the number of tubes 804. The undersurface of the base layer 810 may be coated with a flexible skin friendly silicone adhesive 811 such as Silbione (see e.g. FIGS. 12 and 13). The flexible and elastic tubular structure 802 is wrapped around the limb 100 or part thereof and the base layer 810 adheres directly to the skin. When wrapped around the limb 100 the distension device 800 may adopt a circular shape. Shape changes in the distension device 800 may be transferred to the skin because the distension device 800 is in direct connection to the skin. When inflated with air, the tubes 804 elongate and the circumference formed by the tubes 804 expands, and the area contained within the circle increases. Multiple tubes 804 that are reinforced may be fully or partially imbedded into the base layer 810 that may be elastic. A layer of silicone adhesive 811 may be coated under the surface. Accordingly, as the tubes 804 are adhered to the skin when the tubes 804 are inflated the tubes 804 may apply an outward pulling force (decompression force or negative distending force) to the skin. Alternatively, when a vacuum is applied to the tubes 804, the tubes 804 shorten and compress the tissue.

With specific reference to FIG. 12, a cross-sectional diagram shows the flexible and elastic tubular structure 802 adhered around a limb 100. The proximal and distal hook and loop connections 812, 812′ links the proximal end 831 and the distal end 831 together preferably over a bony surface such as a shin. When the pressure is raised within the tubes 804, the tubes 804 elongate and the distension device 800 expands, producing decompression within the tissue. Alternatively, when a vacuum is applied to the tubes 804, the tubes 804 shrink, causing compression. The double headed arrows in FIG. 12 show the direction of the expansion and contraction forces when the pressure in the tubes 804 is increased or decreased respectively. In some cases, the changes in pressure applied to the skin may be transmitted into the limb 100 to influence the shape of the capillaries, veins and arteries, thereby influencing flow of body fluids. Although FIG. 12 illustrates an embodiment with a gap in circumferential coverage, in one embodiment, at least one tube or the tubes 804 are configured on the base layer 810 such that the tubes 804 are completely circumferentially surrounding the limb 100 without any gaps in circumferential coverage when the device 800 is attached.

In some cases, where skin integrity may be compromised and not suitable for the direct adhesion of the silicone tubes as in the situation of an ulcer, the skin wound may be covered with a layer of flexible elastic material such as silicone or a hydrocolloid material such as Duoderm that attaches to the skin margins around the wound/ulcer thereby providing a flexible elastic surface over the compromised area of skin. This can be done, if necessary, prior to the application of the distension device 800. The covering material may be lifted away from the wound when the tubes 804 are inflated and a negative pressure generated in the wound. Intermittent low-pressure negative pressure is a standard method of treating wounds. The negative pressure generated in the ulcer may be measured with a pressure sensor. The pressure in the ulcer may be measured simply with a thin hollow tube connected to a water manometer. The amount of negative pressure generated may be proportional to the pressure used to inflate the tubes 804. Accordingly, the tube inflating pressure will be adjusted in response to the pressure measured by a sensor or water manometer. In some cases, the skin may be protected and adhesion enhanced by applying a skin protective barrier, for example, but not limited to, Skin Prep or Mastisol, prior to adhering the flexible and elastic tubular structure 802.

Accordingly, in one embodiment, the distension device 800 may be a band, a garment or a sleeve. The distension device 800 may fit the desired part of the body 100 such as a limb and may be used to treat vascular insufficiency. The distension device 800 includes a flexible and elastic tubular structure, the tubes 804 attached to the base layer 810. The distension device 800 may include the air supply port 806 and the closed distal end 830, designed such that longitudinal expansion of one or more parts of the tubes 804 and/or base layer 810 is less restricted than radial expansion of the one or more parts of the tubes 804 and/or base layer 810. A fastening element may be attached to the base layer and used to fasten the silicon base layer 810 circumferentially around a limb 100 or part of the body being treated.

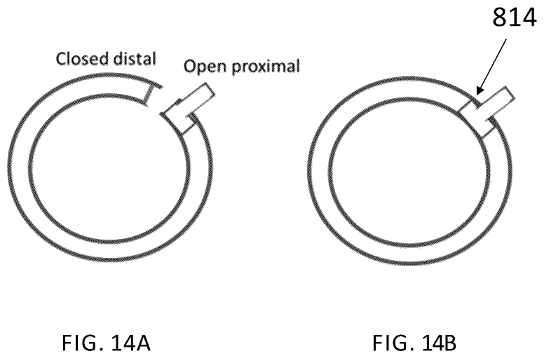

In some embodiments, as shown in FIG. 14A, the distension device 800 may be constructed as a sleeve or sock-type wearable, thus no fastening element is required for placing the wearable device 800 around a limb 100. In these embodiments, the air supply port 806 may be configured at a 3-way junction 814, connecting the distal end 830 and the proximal end 831 of the tubes 804, and allowing the tubes 804 to continuously circumscribe the limb 100 as shown in FIG. 14B with a tee or 3-way junction 814 supplying air pressure. The flexible and elastic tubular structure 802 may then be applied similar to a compression sock or sleeve, rather than by wrapping and fastening. In one embodiment, the flexible and elastic tubular structure 802 may be designed as a long continuous band, using multiple tubes 804 for example, that is wrapped around a limb 100 in a tight spiral. The flexible and elastic tubular structure 802 may be anchored at each end (830 and 831) to the skin with a relatively non-elastic segment. In this embodiment, there is no need to design different lengths of tubes 804 to fit on the changing diameters of a limb 100 such as the lower leg. In one embodiment the flexible and elastic tubular structure 802 would have connectors that would serve to seal the tube 804 while also providing an air supply port 806. This would allow different segments of the tubes 804 in the flexible and elastic tubular structure 802 to be deflated or inflated as needed. For example, in the situation of venous insufficiency where blood pools in the veins of the legs, sequential compression of the foot then calf will promote the return of blood. Venous compression is a standard form of treatment for venous stasis and is usually provided by compression stockings or in some cases by inflatable pillows around the legs. This is a common practice to prevent venous thrombosis post anesthesia.

In one embodiment, the distension device 800 has multiple tubes 804. In one embodiment, each of the tubes 804 has a closed distal end 830 and an open proximal end 831 connected to the air supply port 806 via a proximal end branch 807. In one embodiment, the fastening element has a proximal and distal end fastening component configured to mate with each other. In one embodiment, at least one of the proximal and distal end fastening components is a hook and loop fastener. In one embodiment, at least one of the proximal and distal end fastening components is at least one of a magnet, hook, button, clip, zipper, adhesive, buckle, toggle, belt, lace, cord or cinch. In one embodiment, the silicon base layer 810 is substantially planar. In one embodiment, the distension device 800 includes a pneumatic pump 820 connected to the air supply port 806. In one embodiment, a skin adhesive layer 811 is disposed on the base layer 810. In one embodiment, a kit includes the distension device 800 and a skin adhesive 811 and protective material. In one embodiment, a sensor 813 may be attached to at least one of the base layer 810 and/or the tubes 804.

In addition, embodiments described herein also include a method for applying intermittent and sequential biphasic pressures into the tubes 804 so as to generate at least 40 mmHg negative pressure on the skin. The pneumatic pump 820 for provides sequential timed biphasic pressures to the flexible and elastic tubular structure 802. The pump 820 may provide repeated timed inflations to the flexible and elastic tubular structure 802 so as to improve blood flow to the tissue below the flexible and elastic tubular structure 802. For example, the pump 820 could inflate the distension device 800 for 10 seconds and release the pressure to atmospheric or above atmospheric (and apply compression of the venous system) in repeated cycles. Sensors 813 may be embedded into the flexible and elastic tubular structure 802 for measuring pressure applied to the skin. Other sensors 813 for measuring temperature or blood flow may also be included.

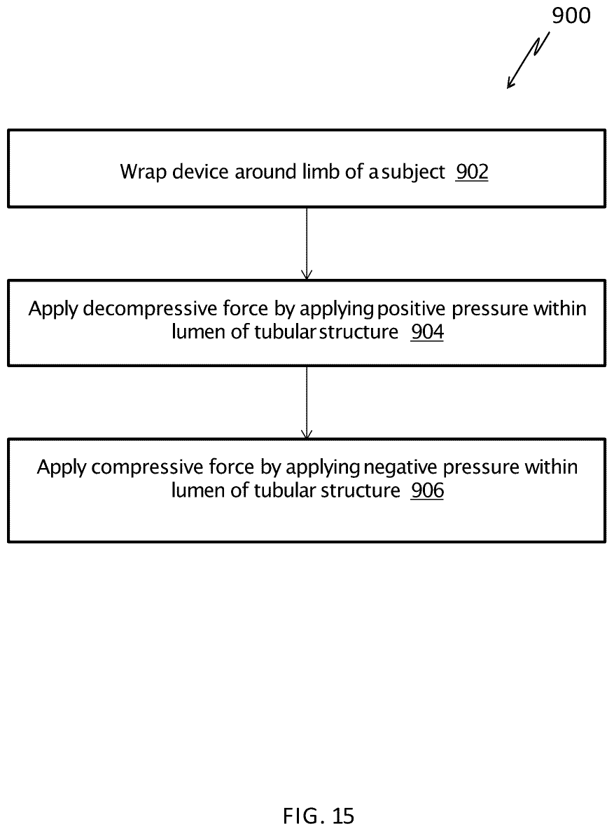

With reference now to FIG. 15, a method 900 for treating vascular insufficiency is described according to one embodiment. The method 900 includes the steps of circumferentially wrapping the base layer 810 around a limb 100 region of a subject (step 902), applying a positive intraluminal pressure within the tubes 804 to decompress the limb 100 region (step 904), and applying a negative intraluminal pressure within the first lumen to compress the limb 100 region (step 906). In one embodiment, at least one of the applying a positive intraluminal pressure (step 904) and applying a negative intraluminal pressure (step 906) is based on sensor feedback. In one embodiment, the sensor feedback is measured from the limb 100 region, including a signal of the pressure generated by the device 800 on the limb 100. In one embodiment, the sensor feedback is a signal indicative of at least one of heart rate, ECG, pulse, blood flow, temperature, respiratory effort, chest displacement and tube function. In one embodiment, the sensor is connected to at least one of the base layer 810 and the tubes 804. In one embodiment, the method 900 includes the step of holding a predetermined positive intraluminal pressure for a predetermined amount of time. In one embodiment, the predetermined positive intraluminal pressure is determined based on sensor feedback. In one embodiment, the predetermined amount of time for inflation pressure to be reached is less than 300 ms and the amount of time the pressure is maintained is adjustable manually or is based on sensor feedback. In one embodiment, the predetermined positive intraluminal pressure is less than full positive intraluminal pressure. In one embodiment, the method 900 includes the step of holding a predetermined negative intraluminal pressure for a predetermined amount of time. In one embodiment, the predetermined negative intraluminal pressure is determined based on sensor feedback. In one embodiment, the predetermined amount of time is based on sensor feedback. In one embodiment, the predetermined negative intraluminal pressure is more than full negative intraluminal pressure. In one embodiment, the method 900 includes the step of attaching the base layer 810 to a limb 100 region of a subject by applying a skin attachment mechanism. In one embodiment, the skin attachment mechanism is a skin adhesive 811. In one embodiment, injured or ulcerated skin can be first covered with a flexible elastic layer of material such as a hydrocolloid prior to adhering the base layer. In one embodiment, the step of applying a negative intraluminal pressure (step 906) comprises multiple pressure changes per minute or high frequency oscillations. In one embodiment, the step of applying a positive intraluminal pressure (step 904) comprises high frequency oscillations. In one embodiment, the method 900 includes the step of oscillating between first and second positive intraluminal pressures. In one embodiment, the method 900 includes the step of oscillating between first and second negative intraluminal pressures. In one embodiment, the method 900 includes the step of oscillating between a positive intraluminal pressure and a negative intraluminal pressure. In one embodiment the timing of the decompression/compression cycles will be determined from the responses from the sensors applied to the limb 100. In one embodiment, the base layer 810 is wrapped around the limb 100 region of the subject in a spiral. In one embodiment, the base layer 810 is anchored to the subject at a first and second anchor region of the base layer 810. In one embodiment, the first and second anchor region of the base layer are inelastic.

The mechanism for improving blood flow, especially in rigid diseased arteries, with negative pressure (decompression) includes widening of peripheral vasculature (veins and capillaries that are still compliant) to lower vascular resistance. By dilation of the distensible venous and capillary bed the arterial-venous pressure gradient is decreased, thereby improving flow. According to Poiseuille's law, the amount of fluid flowing through a rigid tube depends upon the difference in pressure along the tube. Compression may also be applied after decompression to empty the venous and capillary bed selectively and further reduce the gradient. This is the mechanism used in devices that produce intermittent sequential pneumatic compression. However, these devices do not have the benefit of negative pressure (decompression). The improvement in arterial flow can be long lasting and not limited to the time of the decompression therapy. In certain embodiments, improvement in arterial flow can be achieved by intermittent decompression while venous return will be best achieved by compressive forces. The pneumatic pump 820 may provide flexibility in combining the most effective sequence of decompressive and compressive forces to facilitate arterial supply while improving venous return. Providing a rapid sequence of compressive and decompressive forces is a unique advantage to embodiments of the distension device 800 and method 900 described herein.

### Experimental Examples

The invention is now described with reference to the following Examples.

These Examples are provided for the purpose of illustration only and the invention should in no way be construed as being limited to these Examples, but rather should be construed to encompass any and all variations which become evident as a result of the teaching provided herein.

Without further description, it is believed that one of ordinary skill in the art can, using the preceding description and the following illustrative examples, make and utilize the present invention and practice the claimed methods. The following working examples therefore, specifically point out the preferred embodiments of the present invention, and are not to be construed as limiting in any way the remainder of the disclosure.

Depending on the operation mode, the clinician can use various techniques to determine how much pressure to apply to the device. In static pressure mode, if the pressure is being added to provide a relatively constant negative distending pressure to the lung, the clinician will inflate the chest expander sufficiently to notice a slight (approx. 2-3 mm) increase in chest diameter. The pressure used to inflate the expander will be held constant. This will be accompanied by clinical signs of reduced spontaneous breathing effort i.e. reduced respiratory rate, reduced abdominal excursion, reduced nasal flaring, and reduced retractions. If there is a transcutaneous monitor there might be a confirmatory reduction in elevations of carbon dioxide. The need for supplemental oxygen will also be less as the volume of the lung expands.

Over distension of the device will cause an increase of respiratory distress. In high frequency oscillation mode, the expander will be inflated to produce a visible expansion of the chest and a reduction in the need for supplemental oxygen. Oscillatory pressure amplitude will be gradually added to the background inflating pressure in the expander so that a gentle vibration of the chest wall is discernable. The frequency and amplitude will be adjusted according to blood gases. In synchronized to respiratory effort mode, the expander will be inflated in synchrony with the patients effort to breathe, i.e. pressure will be added to the expander at the onset of inspiration when the airway opens. The pressure will be adjusted to reduce clinical signs of respiratory distress and show slight expansion of the chest.

With reference now to FIGS. 16A and 16B, the mannequin setup was used to measure the pressure required to inflate the chest expander and the volume displaced from within the chest cavity. The mannequin represents the size of a 1.5 kg newborn. Chest compression was produced by applying a vacuum to the chest expander. The chest expander consists of silicone tubes (four in this version) embedded in medical grade silicone foam and coated on the skin side with an FDA-approved silicone adhesive for direct application to the skin of the chest wall. The adhesive allows for non-traumatic, repeated removal and reapplication. Inflation of the distending tubes produces an expansion of the chest cavity and the inflow of air as the lungs expand. See short arrows in FIG. 16A. Exhalation was generated by passive recoil. A plethysmography sensor wire is also embedded into the silicone of the chest expander 1002 for measuring chest wall motion. When inflated, the tubes elongate and do not widen since they are reinforced with Kevlar thread. An abdominal RIP sensor 1004 embedded in transparent silicone is also seen on this mannequin. The inflated tube moves the chest outwards and upwards. Data obtained from the mannequin is shown in FIGS. 16B and 16C. A respiratory inductance plethysmography (RIP) signal moves positively (arrow) when the chest expander is inflated showing it increases the chest circumference. Flow into the mannequin coincides with the chest wall expansion in response to the negative pressure generated. The inflating pressure into the expander was varied to produce an average tidal volume of 3.7 ml in the first 4 breaths and 1.7 ml in the next 3. (ref: normal TV is 7 ml for a 1.5 kg infant). These volumes are more than enough for high frequency oscillation.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention.

What is claimed is:

1. A device for treating vascular insufficiency comprising:
a flexible and elastic tubular structure attached to a base layer, the flexible and elastic tubular structure comprising an air inlet, wherein longitudinal expansion of a first portion of the tubular structure is less restricted than radial expansion of the first portion of the tubular structure; and
a fastener attached to the base layer and configured to fasten the base layer circumferentially around a limb.

2. The device of claim 1, wherein the air inlet is a proximal air inlet and the flexible and elastic tubular structure further comprises a closed distal end.

3. The device of claim 1, wherein the flexible and elastic tubular structure comprises a plurality of tubes.

4. The device of claim 3, wherein each of the plurality of tubes has a closed distal end and an open proximal end connected to the proximal air inlet via a proximal end branch.

5. The device of claim 1, wherein the fastener comprises a proximal and distal end fastening component configured to mate with each other.

6. The device of claim 5, wherein at least one of the proximal and distal end fastening components is a hook and loop fastener.

7. The device of claim 5, wherein at least one of the proximal and distal end fastening components is at least one of a magnet, hook, button, clip, zipper, adhesive, buckle, toggle, belt, lace, cord or cinch.

8. The device of claim 1, wherein the base layer is substantially planar.

9. The device of claim 1 further comprising:
a pneumatic pump connected to the air inlet.

10. The device of claim 1 further comprising:
a skin adhesive layer disposed on the base layer.

11. A kit comprising the device of claim 1 and a skin adhesive.

12. The device of claim 1 further comprising:
a sensor attached to at least one of the base layer and the tubular structure.

13. The device of claim 1 wherein the air inlet forms part of a 3-way junction including first and second ends of the flexible and elastic tubular structure.

14. A method for treating vascular insufficiency comprising:
providing the device of claim 1;
circumferentially wrapping the base layer around a limb region of a subject;
applying a positive intraluminal pressure within the tubular structure to decompress the limb region; and
applying a negative intraluminal pressure within the first lumen to compress the limb region.

15. The method of claim 14, wherein at least one of the applying a positive intraluminal pressure and applying a negative intraluminal pressure is based on sensor feedback.

16. The method of claim 15, wherein the sensor feedback is measured from the limb region.

17. The method of claim 15, wherein the sensor feedback is a signal indicative of at least one of heart rate, ECG, blood flow, temperature, respiratory effort, chest displacement and tube function.

18. The method of claim 15, wherein the sensor is connected to at least one of the base layer and the tubular structure.

19. The method of claim 14 further comprising:
holding a predetermined positive intraluminal pressure for an amount of time that is based on sensor feedback.

20. The method of claim 14 further comprising:
attaching the base layer to a limb region of a subject by applying a skin attachment mechanism.
